(19) United States
(12) Patent Application Publication
(10) Pub. No.: US 2026/0252862 A1
(43) Pub. Date: Aug. 27, 2026

(54) SYSTEM

(71) Applicant: SoftBank Group Corp., Tokyo (JP)

(72) Inventor: Naoto AKIYAMA, Tokyo (JP)

(73) Assignee: SoftBank Group Corp., Tokyo (JP)

(21) Appl. No.: 19/542,688

(22) Filed: Feb. 18, 2026

(30) Foreign Application Priority Data
Feb. 21, 2025 (JP) 2025-027004

(51) Int. Cl. G06N 3/0475; G06N 3/0455; G06N 3/0464; G06N 3/092

(52) U.S. Cl. CPC G06N 3/0475; G06N 3/0455; G06N 3/0464; G06N 3/092

(57) ABSTRACT

The system according to the embodiment comprises a reception unit, a collection unit, a generation unit, a placement unit, and a distribution unit. The reception unit is configured to receive a request from a user. The collection unit is configured to collect data based on the request received by the reception unit. The generation unit is configured to analyze the data collected by the collection unit and generate a 3D map. The placement unit is configured to place a character on the 3D map generated by the generation unit. The distribution unit is configured to distribute the 3D map including the character placed by the placement unit.

### CROSS-REFERENCE TO RELATED APPLICATION

The present application claims priority to and incorporates by reference the entire contents of Japanese Patent Application No. 2025-027004 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult to generate a 3D map and place a character without specialized knowledge.

### SUMMARY OF THE INVENTION

The system according to the embodiment comprises a reception unit, a collection unit, a generation unit, a placement unit, and a distribution unit. The reception unit is configured to receive a request from a user. The collection unit is configured to collect data based on the request received by the reception unit. The generation unit is configured to analyze the data collected by the collection unit and generate a 3D map. The placement unit is configured to place a character on the 3D map generated by the generation unit. The distribution unit is configured to distribute the 3D map including the character placed by the placement unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

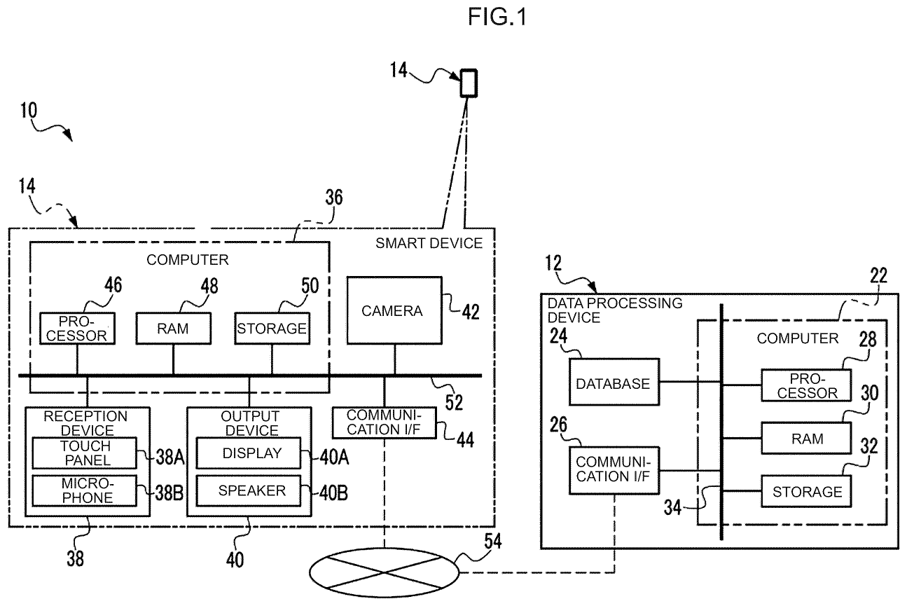

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

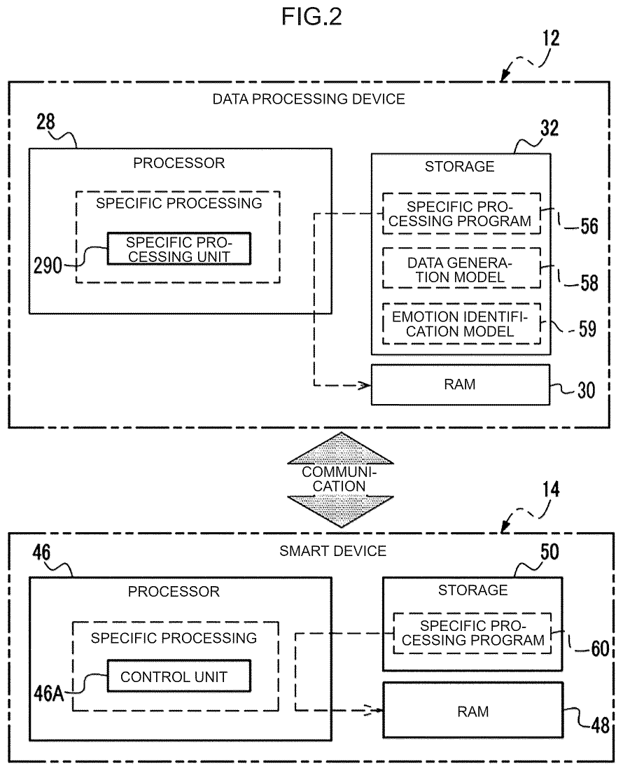

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The 3D map generation system according to the embodiment of the present invention is a system that enables the generation of 3D maps using AI chat, even without specialized knowledge. This system meets the demand for map display in fields such as tourism, education, and video production. Conventionally, extensive knowledge and skills were required, but this system allows users to place voxel-like 3D maps and characters through interaction with AI. By learning from satellite photographs, it is also possible to generate realistic or fictional maps. The use of a dedicated application enables content distribution and creator compensation. For example, a user requests the generation of a 3D map via AI chat, such as by entering a request like “I want you to create a 3D map of a tourist spot.” Next, the AI analyzes the user's request and collects the necessary data, such as satellite photographs and geographic information of the tourist spot. Based on the collected data, the AI generates a voxel-like 3D map. Since the AI has learned from satellite photographs, it can generate maps that closely resemble reality. Furthermore, the user can also request the placement of characters via AI chat, such as by entering a request like “I want you to place a guide character at the tourist spot.” The AI analyzes the user's request and places the character on the 3D map. As a result, users can easily generate 3D maps and characters without specialized knowledge. The generated 3D maps and characters are distributed via a dedicated application. Users can use the dedicated application to share the generated content with other users. In addition, creators can sell the generated content and obtain revenue. For example, by creating a 3D map of a tourist spot and providing it to tourists, revenue can be obtained. Through this system, the demand for map display in fields such as tourism, education, and video production can be met. Users can easily generate 3D maps and characters and distribute content without specialized knowledge. Creators can also obtain revenue by selling the generated content. This is expected to build a new business model in the field of map display. Thus, the 3D map generation system enables users to easily generate 3D maps and characters and distribute content without specialized knowledge. Specifically, the 3D map generation system includes an AI chat module equipped with a large language model with natural language processing functions as a user interface. The AI chat module accepts text input from users (e.g., “I want you to create a 3D map of a tourist spot”) or voice input (e.g., “Create a 3D map of this place”). The input data undergoes preprocessing such as tokenization, normalization, and context analysis, and is input to the encoder layer of the AI chat module. The AI chat module uses a Transformer architecture to perform semantic analysis of the input sentence and extracts the intent of the request (e.g., geographic range, purpose, required level of detail). The extracted intent information is passed to the data collection module. The data collection module automatically acquires satellite photographs (e.g., RGB image tensor, resolution 1024×1024 pixels, shooting date May 1, 2023) and geographic information (e.g., elevation data, feature vector data) of the specified area from external geographic information APIs and satellite image databases. The acquired data undergoes image preprocessing (e.g., noise removal, resizing, normalization), vectorization of geographic information, coordinate system conversion, and is input to the 3D map generation AI. The 3D map generation AI uses, for example, a 3D convolutional neural network (3D-CNN) or an extended Transformer-based generative model to generate voxel data (e.g., 256×256×64 voxel grid, each voxel labeled with surface type and elevation value) from the input satellite image tensor and geographic information vector. The generative AI is pre-trained with a teacher dataset of satellite photographs and geographic information to improve the reproducibility of real terrain. The AI output is structured as 3D map data (e.g., voxel grid, polygon mesh, texture mapping information). When the user requests character placement, the AI chat module extracts parameters such as character type (e.g., guide, tourist, animal), placement location (e.g., landmark coordinates), and behavior pattern (e.g., walking, guiding) from the request sentence. These parameters are input to the character placement AI (e.g., reinforcement learning agent or rule-based placement algorithm), which determines the optimal placement coordinates and behavior sequence on the 3D map. The AI output is structured data such as character ID, placement coordinates, and behavior script. These outputs are integrated with the 3D map data and passed to the distribution module. The distribution module converts the generated 3D map and character information into a data format optimized for dedicated applications (e.g., mobile app, web app) such as glTF, FBX, or proprietary binary format, and performs streaming or download distribution. Users can view and operate the 3D map and share it with other users via the dedicated application. Creators can list the generated content on a marketplace for sale and monetization. Automated processing by AI, unlike manual map creation and character placement, utilizes feature extraction, pattern recognition, and optimization algorithms in high-dimensional space, enabling significant improvements in work efficiency, accuracy, and generation of diverse variations compared to conventional methods. The technical effect is that high-quality 3D map generation is possible without specialized knowledge, enabling the creation of new business models in the map generation and distribution field and application to a wide range of use cases such as education, tourism, and entertainment. Specific application fields include tourist guide apps, virtual geographic teaching materials for education, 3D background generation for video production, urban planning simulation, and game development support.

The 3D map generation system according to the embodiment comprises a reception unit, a collection unit, a generation unit, a placement unit, and a distribution unit. The reception unit is configured to receive a request from a user. The user's request may include, for example, text format, voice format, or specific actions, but is not limited thereto. For example, the reception unit allows the user to input a request such as “I want you to create a 3D map of a tourist spot.” The collection unit is configured to collect data based on the request received by the reception unit. The data to be collected may include, for example, satellite photographs, geographic information, sensor data, user data, or data from external APIs, but is not limited thereto. For example, the collection unit collects satellite photographs and geographic information of a tourist spot. The generation unit is configured to analyze the data collected by the collection unit and generate a 3D map. The generated 3D map may include, for example, voxel-based, polygon-based, or software used, but is not limited thereto. For example, the generation unit generates a voxel-like 3D map. The placement unit is configured to place a character on the 3D map generated by the generation unit. The character to be placed may include, for example, character type, placement location, movement, or placement algorithm, but is not limited thereto. For example, the placement unit places a character on the 3D map based on the user's request. The distribution unit is configured to distribute the 3D map including the character placed by the placement unit. The distribution method may include, for example, streaming, downloading, or protocol used, but is not limited thereto. For example, the distribution unit distributes the generated 3D map and character via a dedicated application. Thus, the 3D map generation system according to the embodiment can generate and distribute a 3D map and character based on the user's request. Some or all of the above-described processing in the generation unit may be performed using AI or without using AI. For example, the generation unit may input the data collected by the collection unit to a generative AI and have the generative AI generate the 3D map. Thus, the generation unit can generate a 3D map and place a character based on the user's request. Furthermore, the distribution unit can distribute the generated 3D map and character via a dedicated application. For example, the distribution unit streams the generated 3D map and character so that the user can view them in real time. The distribution unit may also distribute the generated 3D map and character for download so that the user can view them offline. Thus, the 3D map generation system according to the embodiment can generate and distribute a 3D map and character based on the user's request. Specifically, the 3D map generation system includes an AI chat module equipped with a large language model with natural language processing functions as the reception unit. The AI chat module accepts text input from users (e.g., “I want you to create a 3D map of a tourist spot”) or voice input (e.g., “Create a 3D map of this place”). The input data undergoes preprocessing such as tokenization, normalization, and context analysis, and is input to the encoder layer of the AI chat module. The AI chat module uses a Transformer architecture to perform semantic analysis of the input sentence and extracts the intent of the request (e.g., geographic range, purpose, required level of detail). The extracted intent information is passed to the collection unit. The collection unit automatically acquires satellite photographs (e.g., RGB image tensor, resolution 1024×1024 pixels, shooting date May 1, 2023) and geographic information (e.g., elevation data, feature vector data) of the specified area from external geographic information APIs and satellite image databases. The acquired data undergoes image preprocessing (e.g., noise removal, resizing, normalization), vectorization of geographic information, coordinate system conversion, and is input to the 3D map generation AI of the generation unit. The 3D map generation AI uses, for example, a 3D convolutional neural network (3D-CNN) or an extended Transformer-based generative model to generate voxel data (e.g., 256×256×64 voxel grid, each voxel labeled with surface type and elevation value) from the input satellite image tensor and geographic information vector. The generative AI is pre-trained with a teacher dataset of satellite photographs and geographic information to improve the reproducibility of real terrain. The AI output is structured as 3D map data (e.g., voxel grid, polygon mesh, texture mapping information). When the user requests character placement, the AI chat module extracts parameters such as character type (e.g., guide, tourist, animal), placement location (e.g., landmark coordinates), and behavior pattern (e.g., walking, guiding) from the request sentence. These parameters are input to the character placement AI of the placement unit (e.g., reinforcement learning agent or rule-based placement algorithm), which determines the optimal placement coordinates and behavior sequence on the 3D map. The AI output is structured data such as character ID, placement coordinates, and behavior script. These outputs are integrated with the 3D map data and passed to the distribution unit. The distribution unit converts the generated 3D map and character information into a data format optimized for dedicated applications (e.g., mobile app, web app) such as glTF, FBX, or proprietary binary format, and performs streaming or download distribution. Users can view and operate the 3D map and share it with other users via the dedicated application. Creators can list the generated content on a marketplace for sale and monetization. Automated processing by AI, unlike manual map creation and character placement, utilizes feature extraction, pattern recognition, and optimization algorithms in high-dimensional space, enabling significant improvements in work efficiency, accuracy, and generation of diverse variations compared to conventional methods. The technical effect is that high-quality 3D map generation is possible without specialized knowledge, enabling the creation of new business models in the map generation and distribution field and application to a wide range of use cases such as education, tourism, and entertainment. Specific application fields include tourist guide apps, virtual geographic teaching materials for education, 3D background generation for video production, urban planning simulation, and game development support.

The collection unit is capable of collecting satellite photographs or geographic information. For example, the collection unit collects satellite photographs. Satellite photographs may include, for example, resolution, shooting date, provider, but are not limited thereto. The collection unit also collects geographic information. Geographic information may include, for example, terrain data, map data, provider, but is not limited thereto. Thus, by collecting satellite photographs and geographic information, the collection unit can generate a 3D map that closely resembles reality. Some or all of the above-described processing in the collection unit may be performed using AI or without using AI. For example, the collection unit may input satellite photographs and geographic information to a generative AI and have the generative AI perform data collection. Specifically, the collection unit can automatically acquire satellite photographs (e.g., RGB image tensor, resolution 1024×1024 pixels, shooting date May 1, 2023) and geographic information (e.g., elevation data, feature vector data, GeoJSON format feature attributes) of the specified area from external geographic information APIs and satellite image databases. The collection unit performs image preprocessing such as noise removal, resizing, and normalization on the acquired satellite photograph data, and coordinate system conversion and vectorization processing on the geographic information. The collection unit outputs these preprocessed data as high-dimensional tensors (e.g., 4D tensor: batch size×channel count×height×width) or structured vector data for input to the 3D map generation AI or subsequent analysis modules. When using AI, the collection unit inputs the user's request sentence (e.g., “I want you to create a 3D map of the area around Tokyo Station in the summer of 2022”) to a natural language processing AI, which extracts the geographic range, period, and required data types from the request. The extraction results are passed to a data collection AI (e.g., reinforcement learning agent or rule-based crawler), which autonomously determines the selection of external APIs, optimization of data acquisition parameters, and adjustment of acquisition timing. The AI output is structured data such as a list of data types to be acquired (e.g., satellite images, elevation data, feature attributes), target acquisition range (e.g., latitude-longitude rectangle), and acquisition priority score (e.g., prioritize satellite images with a score of 0.95). The collection unit automates the actual data acquisition process based on these outputs. AI-based data collection optimization is technically superior in that, unlike manual data selection and API operation, it simultaneously considers multidimensional features such as past acquisition history, real-time network conditions, and data quality indicators, and dynamically determines the optimal data acquisition strategy. The technical effect is that the collection unit can collect necessary data with high accuracy and speed, improving the accuracy of 3D map generation, overall processing efficiency, and reducing communication load. Specific application fields include urban planning simulation, disaster response map generation, tourist guide apps, virtual geographic teaching materials for education, and 3D background generation for video production.

The generation unit is capable of generating a voxel 3D map. For example, the generation unit generates a voxel 3D map. Voxels may include, for example, voxel size, generation algorithm, but are not limited thereto. The generation unit can adjust the voxel size to generate a detailed 3D map. The generation unit can also adjust the generation algorithm to efficiently generate a 3D map. Thus, by generating a voxel-like 3D map, the generation unit enables detailed map display. Some or all of the above-described processing in the generation unit may be performed using AI or without using AI. For example, the generation unit may input voxel size and generation algorithm to a generative AI and have the generative AI generate the 3D map. Specifically, the generation unit inputs satellite image tensors received from the collection unit (e.g., 2D array of 1024×1024 pixels with RGB values) and geographic information vectors (e.g., elevation value array, feature label array) to the 3D map generation AI. The 3D map generation AI uses, for example, a 3D convolutional neural network (3D-CNN) or an extended Transformer-based generative model to generate a voxel grid (e.g., 25×256×64 3D array, each voxel labeled with surface type and elevation value) from the input data. The AI model is pre-trained with a teacher dataset of satellite images and geographic information (e.g., pairs of actual terrain data and corresponding satellite images), and uses loss functions such as terrain reproduction error (e.g., mean squared error of elevation values) and surface type classification error (e.g., cross-entropy loss). The generation unit can dynamically adjust voxel size (e.g., 1 m×1 m×1 m, 0.5 m×0.5 m×0.5 m) and generation algorithm parameters (e.g., number of convolutional layers, number of attention heads, number of generation steps) according to user requests and system load. The AI output is structured as 3D map data (e.g., voxel grid, polygon mesh, texture mapping information) and passed to subsequent character placement and distribution units. When not using AI, similar 3D maps can be generated using rule-based terrain generation algorithms (e.g., marching cubes method, Perlin noise generation). AI-based generation is technically superior in that, unlike manual work or conventional rule-based generation, it utilizes feature extraction, pattern recognition, and optimization algorithms in high-dimensional space, enabling improved reproducibility of real terrain, generation of diverse variations, and significant increase in generation speed. The technical effect is that the generation unit enables high-quality and diverse 3D map generation without specialized knowledge, creating new business models in the map generation and distribution field and enabling application to a wide range of use cases such as education, tourism, and entertainment. Specific application fields include tourist guide apps, virtual geographic teaching materials for education, 3D background generation for video production, urban planning simulation, and game development support.

The placement unit is capable of placing a character on the 3D map based on the user's request. For example, the placement unit places a character on the 3D map based on the user's request. The user's request may include, for example, character type, placement location, but is not limited thereto. The placement unit can select the character type and place it on the 3D map. The placement unit can also select the placement location and efficiently place the character. Thus, by placing a character based on the user's request, the placement unit can provide a customized 3D map. Some or all of the above-described processing in the placement unit may be performed using AI or without using AI. For example, the placement unit may input character type and placement location to a generative AI and have the generative AI perform character placement. Specifically, the placement unit inputs the user's request sentence (e.g., “I want you to place a guide character at the tourist spot”) to the AI chat module, and a natural language processing AI (e.g., Transformer-based large language model) extracts parameters such as character type (e.g., guide, tourist, animal), placement location (e.g., landmark coordinates), and behavior pattern (e.g., walking, guiding). The extracted parameters are input to the character placement AI (e.g., reinforcement learning agent or rule-based placement algorithm). The placement AI determines the optimal placement coordinates and behavior sequence on the 3D map, taking into account terrain information and the placement status of existing objects. Examples of AI input include character type vectors (e.g., one-hot encoding), placement candidate coordinate lists (e.g., 3D coordinate arrays), and terrain feature tensors (e.g., elevation, surface type, presence of obstacles). The AI output is structured data such as character ID, placement coordinates, and behavior script, for example, “Character ID: 001, coordinates: (120,45,10), action: start guiding.” As a subsequent process, these outputs are integrated with the 3D map data and passed to the distribution unit. AI-based placement optimization is technically superior in that, unlike manual work or conventional rule-based placement, it simultaneously considers multidimensional features such as terrain, user requests, and relationships between characters, and utilizes optimization algorithms (e.g., reward maximization, collision avoidance, user experience improvement), resulting in significant improvements in placement accuracy, diversity, and work efficiency. The technical effect is that the placement unit enables highly customizable 3D map generation according to diverse user requirements, and can be utilized in a wide range of fields such as education, tourism, games, and video production. Specific application fields include tourist guide apps, virtual geographic teaching materials for education, game development support, and virtual event space design.

The distribution unit is capable of distributing the generated 3D map and character via an application. For example, the distribution unit distributes the generated 3D map and character via an application. The application may include, for example, mobile apps, web apps, provided functions, but is not limited thereto. The distribution unit can distribute the 3D map and character via a mobile app. The distribution unit can also distribute the 3D map and character via a web app. Thus, by distributing the 3D map and character via a dedicated application, the distribution unit enables users to share generated content with other users. Some or all of the above-described processing in the distribution unit may be performed using AI or without using AI. For example, the distribution unit may input the generated 3D map and character to a generative AI and have the generative AI perform the distribution method. Specifically, the distribution unit converts the 3D map data (e.g., voxel grid, polygon mesh, texture mapping information) and character information (e.g., character ID, placement coordinates, behavior script) received from the generation unit and placement unit into a data format optimized for the target application (e.g., glTF, FBX, proprietary binary format). For streaming distribution, the distribution unit divides the data and transmits it sequentially, enabling users to view and operate the 3D map in real time on their devices. For download distribution, the distribution unit transmits all data at once, allowing users to use it offline. When using AI, the distribution unit inputs features such as user device specifications (e.g., CPU/GPU performance, memory capacity), network bandwidth, and user usage history (e.g., past viewing trends, communication environment) to the AI, which automatically determines the optimal distribution method (e.g., switching between high/low resolution, selecting streaming/download, adjusting data compression rate). The AI output is structured data such as distribution method label (e.g., streaming, download), data compression parameter (e.g., JPEG compression rate 0.8), and distribution priority score (e.g., prioritize high resolution with a score of 0.92). As a subsequent process, the distribution unit executes data conversion and transmission processing according to the AI output. AI-based distribution optimization is technically superior in that, unlike manual work or conventional fixed distribution settings, it analyzes real-time device and network conditions and user behavior patterns in multiple dimensions, and dynamically determines the optimal distribution strategy, resulting in reduced communication load, improved user experience, and reduced distribution costs. Specific application fields include tourist guide apps, virtual geographic teaching materials for education, 3D background distribution for video production, urban planning simulation, and game development support.

The distribution unit is capable of selling content generated by a creator and obtaining revenue. For example, the distribution unit sells content generated by a creator and obtains revenue. Content generated by a creator may include, for example, 3D models, animations, generation tools, but is not limited thereto. The distribution unit can sell 3D models and obtain revenue. The distribution unit can also sell animations and obtain revenue. Thus, by selling content generated by a creator, the distribution unit can obtain revenue. Some or all of the above-described processing in the distribution unit may be performed using AI or without using AI. For example, the distribution unit may input the generated content to a generative AI and have the generative AI perform the sales method. Specifically, the distribution unit converts creator-generated 3D model data (e.g., glTF format, FBX format), animation data (e.g., BVH format, motion capture data), and generation tools (e.g., map editor, character placement script) into formats optimized for marketplaces or distribution platforms, and executes sales and distribution processing. When using AI, the distribution unit inputs features such as content attributes (e.g., genre, target user group, price range), past sales performance data, user purchase history, and real-time market trends to the AI, which automatically determines the optimal sales strategy (e.g., price setting, promotion method, sales channel selection). The AI output is structured data such as sales price (e.g., $9.99), promotion measures (e.g., limited-time discount, bundle sale), and sales priority score (e.g., prioritize education field with a score of 0.85). As a subsequent process, the distribution unit automates sales page generation, promotion distribution, and sales management according to the AI output. AI-based sales optimization is technically superior in that, unlike manual work or conventional fixed sales settings, it analyzes real-time market trends and user behavior patterns in multiple dimensions, and dynamically determines the optimal sales strategy, resulting in maximized revenue, improved sales efficiency, and reduced inventory risk. Specific application fields include 3D model marketplaces, educational material sales, game development support tool distribution, video production material sales, and virtual event content sales.

The reception unit is capable of estimating a user's emotion and adjusting a method of receiving a request based on the estimated emotion of the user. For example, if the user is feeling stressed, the reception unit provides a simple interface and minimizes input steps. If the user is relaxed, the reception unit may provide detailed input options and suggest customizable input methods. Furthermore, if the user is in a hurry, the reception unit may prioritize voice input to enable quick request reception. Thus, by adjusting the method of receiving a request according to the user's emotion, the reception unit enables more appropriate request reception. Emotion estimation is realized using, for example, an emotion engine or generative AI with emotion estimation functions. The generative AI may be a text generative AI (e.g., LLM) or a multimodal generative AI, but is not limited thereto. Some or all of the above-described processing in the reception unit may be performed using AI or without using AI. For example, the reception unit may input the user's emotion data to a generative AI and have the generative AI adjust the method of receiving a request. Specifically, the reception unit accepts various modalities of input data from the user, such as text (e.g., “I want to create a 3D map right now”), voice (e.g., “I'm in a hurry, please make it simple”), facial images (e.g., face image captured by camera), and biometric sensor data (e.g., heart rate, skin conductance). The reception unit preprocesses these input data in a preprocessing module for normalization and feature extraction (e.g., voice spectrum conversion, extraction of facial feature vectors from images, calculation of statistical values from time-series biometric data), and inputs them to an emotion estimation AI. The emotion estimation AI uses, for example, a multimodal Transformer or an architecture combining convolutional neural networks and recurrent neural networks to output emotion labels (e.g., stress, relaxation, tension, excitement) and emotion intensity scores (e.g., stress level 0.85, relaxation level 0.15) from the input features. Examples of AI input include a 128-dimensional facial feature vector, a 256-dimensional voice spectrum vector, and a 10-dimensional biometric sensor statistical vector. Examples of AI output include “Emotion label: stress, score: 0.92” and “Emotion label: relaxation, score: 0.78.” Based on these AI outputs, the reception unit dynamically switches the user interface (e.g., reduces the number of buttons, automatically omits input items, automatically selects voice input mode), presents input guides (e.g., “Proceed with simple operation,” “Detailed settings are also available”), and executes subsequent processing. AI-based emotion estimation and reception method optimization is technically superior in that, unlike subjective judgment by human operators or fixed UI design, it simultaneously analyzes high-dimensional features from multiple modalities and autonomously determines the optimal reception strategy in real time according to the user's state. The technical effect is that the reception unit can reduce the user's psychological burden, decrease input errors and dropout rate, and greatly improve user experience. Specific application fields include stress-free reception in tourist guide apps, user state-adaptive UI for educational material creation, efficient reception in video production support tools, and information input support according to patient state in medical settings.

The reception unit is capable of analyzing a user's past request history and selecting an appropriate reception method. For example, the reception unit automatically displays requests that the user has frequently entered in the past as candidates. The reception unit may also preferentially suggest reception methods (voice, text, etc.) that the user has used in the past. Furthermore, the reception unit may predict and suggest requests to be used at specific times based on the user's past request history. Thus, by analyzing the user's past request history, the reception unit can select the optimal reception method. Some or all of the above-described processing in the reception unit may be performed using AI or without using AI. For example, the reception unit may input the user's past request history to a generative AI and have the generative AI select the reception method. Specifically, the reception unit obtains request history data accumulated in chronological order for each user (e.g., request content text, reception date and time, interface type used, input time required, success/failure flag) from a database. The reception unit inputs these history data as feature vectors (e.g., embedded vectors of request content, one-hot vectors of day of week/time, category vectors of interface type) to an AI model. The AI model may be a recurrent neural network (e.g., LSTM) or a Transformer-based history analysis model with self-attention mechanism, which excels at extracting time-series patterns. Examples of AI input include embedded vectors of the last 30 requests (each 256-dimensional), reception time vectors (24-dimensional), and interface type vectors (3-dimensional: text/voice/image). Examples of AI output include “Recommended reception method: voice input, confidence 0.87” and “Recommended candidate request: ‘Create a 3D map of a tourist spot,’ score 0.92.” Based on the AI output, the reception unit automatically selects the recommended reception method on the user interface, displays candidate requests that frequently occurred in the past, and switches reception modes according to the time of day (e.g., hide voice input at night), and executes subsequent processing. AI-based history analysis and reception optimization is technically superior in that, unlike human memory or simple history list display, it analyzes multiple history patterns and usage trends in high-dimensional space and autonomously provides an optimized reception experience for each user. The technical effect is that the reception unit can reduce the user's input burden, improve reception efficiency and satisfaction, and reduce input errors and operation time. Specific application fields include personalized reception in tourist guide apps, support for educational material creation, history-based reception in video production tools, and efficient reception in business systems.

The reception unit is capable of performing filtering based on the user's current project or field of interest when receiving a request. For example, if the user wants to create a 3D map of a tourist spot, the reception unit prioritizes information related to tourist spots. If the user wants to create a 3D map for educational purposes, the reception unit may prioritize information related to education. Furthermore, if the user wants to create a 3D map for video production, the reception unit may prioritize information related to video production. Thus, by performing filtering based on the user's current project or field of interest, the reception unit can preferentially receive highly relevant requests. Some or all of the above-described processing in the reception unit may be performed using AI or without using AI. For example, the reception unit may input the user's project or field of interest data to a generative AI and have the generative AI perform filtering. Specifically, the reception unit obtains user profile data (e.g., current project name, field of interest tags, past usage history, selected category) and inputs these as feature vectors (e.g., one-hot vectors of project type, embedded vectors of field of interest) to an AI model. The AI model may be a multilayer perceptron or a Transformer-based text classification model suitable for category classification. Examples of AI input include “Project type: tourist map creation, field of interest: history/culture” and “Project type: educational material, field of interest: geography/science.” Examples of AI output include “Recommended reception category: tourist-related, score 0.93” and “Recommended reception category: education-related, score 0.88.” Based on the AI output, the reception unit prioritizes the display of highly relevant request items on the reception screen, hides unnecessary items, or dynamically switches input guides, and executes subsequent processing. AI-based project/field of interest filtering is technically superior in that, unlike manual category selection or static UI design, it autonomously optimizes the reception experience according to the user's current purpose and interest. The technical effect is that the reception unit enables request reception that matches the user's purpose, improves input efficiency and satisfaction, and reduces erroneous or irrelevant requests. Specific application fields include project-based reception in tourist guide apps, support for educational material creation, category-based reception in video production tools, and purpose-based reception in business systems.

The reception unit is capable of estimating a user's emotion and determining the priority of requests to be received based on the estimated emotion of the user. For example, if the user is nervous, the reception unit prioritizes important requests. If the user is relaxed, the reception unit may prioritize normal requests. Furthermore, if the user is in a hurry, the reception unit may prioritize urgent requests. Thus, by determining the priority of requests according to the user's emotion, the reception unit can preferentially receive important requests. Emotion estimation is realized using, for example, an emotion engine or generative AI with emotion estimation functions. The generative AI may be a text generative AI (e.g., LLM) or a multimodal generative AI, but is not limited thereto. Some or all of the above-described processing in the reception unit may be performed using AI or without using AI. For example, the reception unit may input the user's emotion data to a generative AI and have the generative AI determine the priority of requests. Specifically, the reception unit preprocesses emotion-related data obtained from the user (e.g., voice tone, facial images, emotional vocabulary in input sentences, heart rate) and inputs it to an emotion estimation AI. The emotion estimation AI uses a multimodal neural network to output emotion labels (e.g., tension, relaxation, urgency) and emotion intensity scores from the input features. Examples of AI input include a 128-dimensional voice spectrum vector, a 64-dimensional facial feature vector, and a 1-dimensional emotion score from input sentences. Examples of AI output include “Emotion: tension, score 0.91” and “Emotion: urgency, score 0.85.” Based on the AI output, the reception unit assigns priority scores to each request in the request reception queue and preferentially receives and processes requests with high importance or urgency. As a subsequent process, the reception unit may highlight high-priority requests on the UI or automatically adjust the order of reception. AI-based emotion-based priority determination is technically superior in that, unlike subjective judgment by human operators or fixed priority settings, it analyzes the user's state using multidimensional features and autonomously determines the optimal reception order in real time. The technical effect is that the reception unit enables rapid reception of important requests according to the user's psychological state, prevents overlooking urgent cases, and improves overall reception efficiency. Specific application fields include emergency request reception in tourist guide apps, priority reception of important issues in educational settings, patient state-adaptive reception in medical settings, and priority control in video production support tools.

The reception unit is capable of preferentially receiving highly relevant requests by considering the user's geographic location information when receiving a request. For example, if the user is in a specific region, the reception unit prioritizes requests related to that region. If the user is traveling, the reception unit may prioritize requests related to the travel destination. Furthermore, if the user is at home, the reception unit may prioritize requests related to the area around the home. Thus, by considering the user's geographic location information, the reception unit can preferentially receive highly relevant requests. Some or all of the above-described processing in the reception unit may be performed using AI or without using AI. For example, the reception unit may input the user's geographic location information to a generative AI and have the generative AI perform filtering of requests. Specifically, the reception unit inputs geographic location information obtained from the user's device, such as GPS coordinates (e.g., latitude 35.6812, longitude 139.7671), location accuracy, stay history, and movement speed, as feature vectors to an AI model. The AI model may be a neural network suitable for geographic clustering or location information classification (e.g., multilayer perceptron or Transformer-based model handling geographic features). Examples of AI input include “Current location: around Tokyo Station, in transit” and “Current location: home, stationary.” Examples of AI output include “Recommended reception category: Tokyo tourist spot-related, score 0.95” and “Recommended reception category: home area information, score 0.88.” Based on the AI output, the reception unit prioritizes the display of request items related to the current location or destination on the reception screen, hides unnecessary items, or dynamically switches input guides, and executes subsequent processing. AI-based geographic information filtering is technically superior in that, unlike manual location selection or static UI design, it autonomously optimizes the reception experience according to the user's current location and movement status. The technical effect is that the reception unit enables request reception that matches the user's current location or destination, improves input efficiency and satisfaction, and reduces irrelevant requests and enhances location-linked services. Specific application fields include location-linked reception in tourist guide apps, destination reception in travel support services, home area reception in community-based information services, and on-site reception in urban planning simulation.

The reception unit is capable of analyzing the user's social media activity when receiving a request and receiving relevant requests. For example, if the user posts about tourist spots on social media, the reception unit prioritizes requests related to those tourist spots. If the user posts about education on social media, the reception unit may prioritize requests related to education. Furthermore, if the user posts about video production on social media, the reception unit may prioritize requests related to video production. Thus, by analyzing the user's social media activity, the reception unit can preferentially receive relevant requests. Some or all of the above-described processing in the reception unit may be performed using AI or without using AI. For example, the reception unit may input the user's social media activity to a generative AI and have the generative AI perform filtering of requests. Specifically, the reception unit inputs post data obtained from the user's linked social media accounts (e.g., text posts, image posts, hashtags, post date and time, number of likes) to a natural language processing AI or image analysis AI. The AI model may be a Transformer-based text classification model or an image feature extraction model, which extracts fields of interest or topic categories from the post content. Examples of AI input include “Post text: ‘Last week, I toured temples in Kyoto,’” “Post image: landscape photo of a tourist spot,” and “Hashtags: #education #geography.” Examples of AI output include “Interest category: tourist spot, score 0.91” and “Interest category: education, score 0.87.” Based on the AI output, the reception unit prioritizes the display of request items related to the user's latest field of interest on the reception screen, hides unnecessary items, or dynamically switches input guides, and executes subsequent processing. AI-based social media activity analysis is technically superior in that, unlike manual post checking or static category selection, it analyzes the user's latest interests in high-dimensional features and optimizes the reception experience in real time. The technical effect is that the reception unit enables request reception that matches the user's latest interests, improves input efficiency and satisfaction, and reduces irrelevant requests and enhances trend-linked services. Specific application fields include trend reception in tourist guide apps, support for educational material creation, topic-linked reception in video production tools, and field-of-interest reception in event guide services.

The collection unit is capable of estimating a user's emotion and adjusting a method of data collection based on the estimated emotion of the user. For example, if the user is relaxed, the collection unit collects detailed data. If the user is in a hurry, the collection unit may collect only the minimum necessary data. Furthermore, if the user is excited, the collection unit may collect visually stimulating data. Thus, by adjusting the method of data collection according to the user's emotion, the collection unit enables more appropriate data collection. Emotion estimation is realized using, for example, an emotion engine or generative AI with emotion estimation functions. The generative AI may be a text generative AI (e.g., LLM) or a multimodal generative AI, but is not limited thereto. Some or all of the above-described processing in the collection unit may be performed using AI or without using AI. For example, the collection unit may input the user's emotion data to a generative AI and have the generative AI adjust the method of data collection. Specifically, the collection unit accepts various modalities of emotion-related data obtained from the user, such as text input (e.g., “I want to leisurely view tourist spots today”), voice input (e.g., “I'm in a hurry, please make it simple”), facial images (e.g., face image captured by camera), and biometric sensor data (e.g., heart rate, skin conductance). The collection unit preprocesses these input data in a preprocessing module for normalization and feature extraction (e.g., voice spectrum conversion, extraction of facial feature vectors from images, calculation of statistical values from time-series biometric data), and inputs them to an emotion estimation AI. The emotion estimation AI uses, for example, a multimodal Transformer or an architecture combining convolutional neural networks and recurrent neural networks to output emotion labels (e.g., relaxation, urgency, excitement) and emotion intensity scores (e.g., relaxation level 0.85, urgency level 0.10, excitement level 0.05) from the input features. Examples of AI input include a 128-dimensional facial feature vector, a 256-dimensional voice spectrum vector, and a 10-dimensional biometric sensor statistical vector. Examples of AI output include “Emotion label: relaxation, score: 0.92” and “Emotion label: urgency, score: 0.78.” Based on these AI outputs, the collection unit dynamically switches data collection strategies. For example, if the relaxation level is high, the collection unit collects high-resolution, highly detailed data from various data sources such as satellite photographs, geographic information, detailed feature attributes, and past weather data. If the urgency level is high, the collection unit limits data collection to the minimum necessary (e.g., low-resolution satellite images, only major landmark information) to shorten collection time. If the excitement level is high, the collection unit prioritizes the collection of visually impactful images, colorful feature data, and event information. AI-based emotion-based data collection optimization is technically superior in that, unlike subjective judgment by human operators or fixed collection rules, it simultaneously analyzes high-dimensional features from multiple modalities and autonomously determines the optimal collection strategy in real time according to the user's state. The technical effect is that the collection unit enables data collection tailored to the user's psychological state and purpose, reduces unnecessary data acquisition, improves collection efficiency, and optimizes user experience. Specific application fields include user state-adaptive data collection in tourist guide apps, learner state-linked data acquisition in educational material creation, effect optimization data collection in video production support tools, and information collection support according to patient state in medical settings.

The collection unit is capable of referring to the user's past request history when collecting data and selecting an appropriate data collection method. For example, the collection unit selects the optimal data collection method based on data previously collected by the user. The collection unit may also prioritize the collection of highly relevant data based on the user's past request history. Furthermore, the collection unit may analyze the user's past request history and select the most efficient data collection method. Thus, by referring to the user's past request history, the collection unit can select the optimal data collection method. Some or all of the above-described processing in the collection unit may be performed using AI or without using AI. For example, the collection unit may input the user's past request history to a generative AI and have the generative AI select the data collection method. Specifically, the collection unit obtains request history data accumulated in chronological order for each user (e.g., request content text, reception date and time, collected data type, collection time required, success/failure flag) from a database. The collection unit inputs these history data as feature vectors (e.g., embedded vectors of request content, one-hot vectors of day of week/time, category vectors of data type) to an AI model. The AI model may be a recurrent neural network (e.g., LSTM) or a Transformer-based history analysis model with self-attention mechanism, which excels at extracting time-series patterns. Examples of AI input include embedded vectors of the last 30 requests (each 256-dimensional), collection time vectors (24-dimensional), and data type vectors (5-dimensional: satellite image/geographic information/sensor/user/external API). Examples of AI output include “Recommended collection method: prioritize external API, confidence 0.87” and “Recommended data type: geographic information, score 0.92.” Based on the AI output, the collection unit automatically selects data collection strategies, prioritizes the acquisition of frequently collected data types, and switches collection modes according to time of day and usage trends (e.g., only acquire low-resolution data at night), and executes subsequent processing. AI-based history analysis and collection optimization is technically superior in that, unlike human memory or simple history list display, it analyzes multiple history patterns and usage trends in high-dimensional space and autonomously provides an optimized data collection experience for each user. The technical effect is that the collection unit can reduce the user's input burden, improve collection efficiency and satisfaction, and reduce unnecessary data acquisition, communication costs, and collection time. Specific application fields include personalized collection in tourist guide apps, support for educational material creation, history-based data acquisition in video production tools, and efficient data collection in business systems.

The collection unit is capable of performing filtering based on the user's current project or field of interest when collecting data. For example, if the user wants to create a 3D map of a tourist spot, the collection unit prioritizes the collection of data related to tourist spots. If the user wants to create a 3D map for educational purposes, the collection unit may prioritize the collection of data related to education. Furthermore, if the user wants to create a 3D map for video production, the collection unit may prioritize the collection of data related to video production. Thus, by performing filtering based on the user's current project or field of interest, the collection unit can preferentially collect highly relevant data. Some or all of the above-described processing in the collection unit may be performed using AI or without using AI. For example, the collection unit may input the user's project or field of interest data to a generative AI and have the generative AI perform filtering. Specifically, the collection unit obtains user profile data (e.g., current project name, field of interest tags, past usage history, selected category) and inputs these as feature vectors (e.g., one-hot vectors of project type, embedded vectors of field of interest) to an AI model. The AI model may be a multilayer perceptron or a Transformer-based text classification model suitable for category classification. Examples of AI input include “Project type: tourist map creation, field of interest: history/culture” and “Project type: educational material, field of interest: geography/science.” Examples of AI output include “Recommended collection category: tourist-related, score 0.93” and “Recommended collection category: education-related, score 0.88.” Based on the AI output, the collection unit prioritizes the display of highly relevant data items on the collection screen, hides unnecessary items, or dynamically switches data acquisition API call parameters, and executes subsequent processing. AI-based project/field of interest filtering is technically superior in that, unlike manual category selection or static UI design, it autonomously optimizes the data collection experience according to the user's current purpose and interest. The technical effect is that the collection unit enables data collection that matches the user's purpose, improves collection efficiency and satisfaction, and reduces erroneous or irrelevant data collection. Specific application fields include project-based data collection in tourist guide apps, support for educational material creation, category-based data acquisition in video production tools, and purpose-based data collection in business systems.

The collection unit is capable of estimating a user's emotion and determining the priority of data to be collected based on the estimated emotion of the user. For example, if the user is nervous, the collection unit prioritizes important data. If the user is relaxed, the collection unit may prioritize normal data. Furthermore, if the user is in a hurry, the collection unit may prioritize urgent data. Thus, by determining the priority of data according to the user's emotion, the collection unit can preferentially collect important data. Emotion estimation is realized using, for example, an emotion engine or generative AI with emotion estimation functions. The generative AI may be a text generative AI (e.g., LLM) or a multimodal generative AI, but is not limited thereto. Some or all of the above-described processing in the collection unit may be performed using AI or without using AI. For example, the collection unit may input the user's emotion data to a generative AI and have the generative AI determine the priority of data. Specifically, the collection unit preprocesses emotion-related data obtained from the user (e.g., voice tone, facial images, emotional vocabulary in input sentences, heart rate) and inputs it to an emotion estimation AI. The emotion estimation AI uses a multimodal neural network to output emotion labels (e.g., tension, relaxation, urgency) and emotion intensity scores from the input features. Examples of AI input include a 128-dimensional voice spectrum vector, a 64-dimensional facial feature vector, and a 1-dimensional emotion score from input sentences. Examples of AI output include “Emotion: tension, score 0.91” and “Emotion: urgency, score 0.85.” Based on the AI output, the collection unit assigns priority scores to each data item in the data collection queue and preferentially collects and processes data with high importance or urgency. As a subsequent process, the collection unit may prioritize high-priority data in API call order or highlight it on the collection screen. AI-based emotion-based priority determination is technically superior in that, unlike subjective judgment by human operators or fixed priority settings, it analyzes the user's state using multidimensional features and autonomously determines the optimal collection order in real time. The technical effect is that the collection unit enables rapid collection of important data according to the user's psychological state, prevents overlooking urgent cases, and improves overall collection efficiency. Specific application fields include emergency data collection in tourist guide apps, priority collection of important teaching materials in educational settings, patient state-adaptive data acquisition in medical settings, and priority control in video production support tools.

The collection unit is capable of preferentially collecting highly relevant data by considering the user's geographic location information when collecting data. For example, if the user is in a specific region, the collection unit prioritizes the collection of data related to that region. If the user is traveling, the collection unit may prioritize the collection of data related to the travel destination. Furthermore, if the user is at home, the collection unit may prioritize the collection of data related to the area around the home. Thus, by considering the user's geographic location information, the collection unit can preferentially collect highly relevant data. Some or all of the above-described processing in the collection unit may be performed using AI or without using AI. For example, the collection unit may input the user's geographic location information to a generative AI and have the generative AI perform filtering of data. Specifically, the collection unit inputs geographic location information obtained from the user's device, such as GPS coordinates (e.g., latitude 35.6812, longitude 139.7671), location accuracy, stay history, and movement speed, as feature vectors to an AI model. The AI model may be a neural network suitable for geographic clustering or location information classification (e.g., multilayer perceptron or Transformer-based model handling geographic features). Examples of AI input include “Current location: around Tokyo Station, in transit” and “Current location: home, stationary.” Examples of AI output include “Recommended collection category: Tokyo tourist spot-related, score 0.95” and “Recommended collection category: home area information, score 0.88.” Based on the AI output, the collection unit prioritizes the display of data items related to the current location or destination on the collection screen, hides unnecessary items, or dynamically switches data acquisition API call parameters, and executes subsequent processing. AI-based geographic information filtering is technically superior in that, unlike manual location selection or static UI design, it autonomously optimizes the data collection experience according to the user's current location and movement status. The technical effect is that the collection unit enables data collection that matches the user's current location or destination, improves collection efficiency and satisfaction, and reduces irrelevant data and enhances location-linked services. Specific application fields include location-linked data collection in tourist guide apps, destination data acquisition in travel support services, home area data collection in community-based information services, and on-site data acquisition in urban planning simulation.

The collection unit is capable of analyzing the user's social media activity when collecting data and collecting relevant data. For example, if the user posts about tourist spots on social media, the collection unit prioritizes the collection of data related to those tourist spots. If the user posts about education on social media, the collection unit may prioritize the collection of data related to education. Furthermore, if the user posts about video production on social media, the collection unit may prioritize the collection of data related to video production. Thus, by analyzing the user's social media activity, the collection unit can preferentially collect relevant data. Some or all of the above-described processing in the collection unit may be performed using AI or without using AI. For example, the collection unit may input the user's social media activity to a generative AI and have the generative AI perform filtering of data. Specifically, the collection unit inputs post data obtained from the user's linked social media accounts (e.g., text posts, image posts, hashtags, post date and time, number of likes) to a natural language processing AI or image analysis AI. The AI model may be a Transformer-based text classification model or an image feature extraction model, which extracts fields of interest or topic categories from the post content. Examples of AI input include “Post text: ‘Last week, I toured temples in Kyoto,’” “Post image: landscape photo of a tourist spot,” and “Hashtags: #education #geography.” Examples of AI output include “Interest category: tourist spot, score 0.91” and “Interest category: education, score 0.87.” Based on the AI output, the collection unit prioritizes the display of data items related to the user's latest field of interest on the collection screen, hides unnecessary items, or dynamically switches data acquisition API call parameters, and executes subsequent processing. AI-based social media activity analysis is technically superior in that, unlike manual post checking or static category selection, it analyzes the user's latest interests in high-dimensional features and optimizes the data collection experience in real time. The technical effect is that the collection unit enables data collection that matches the user's latest interests, improves collection efficiency and satisfaction, and reduces irrelevant data and enhances trend-linked services. Specific application fields include trend data collection in tourist guide apps, support for educational material creation, topic-linked data acquisition in video production tools, and field-of-interest data collection in event guide services.

The generation unit can estimate a user's emotion and adjust the method of generating a 3D map based on the estimated emotion of the user. For example, when the user is relaxed, the generation unit generates a detailed 3D map. When the user is in a hurry, the generation unit can generate a 3D map containing only the minimum necessary information. Furthermore, when the user is excited, the generation unit can generate a 3D map with visually stimulating effects. Thus, by adjusting the method of generating the 3D map according to the user's emotion, the generation unit can generate a more appropriate 3D map. Emotion estimation is realized, for example, by using an emotion estimation function such as an emotion engine or a generative AI. The generative AI may be a text generation AI (e.g., LLM) or a multimodal generative AI, but is not limited to such examples. Some or all of the above-described processing in the generation unit may be performed using AI or without using AI. For example, the generation unit may input the user's emotion data to the generative AI and have the generative AI execute the adjustment of the 3D map generation method. Specifically, the generation unit accepts various modalities as emotion-related data obtained from the user, such as text input (e.g., “I want to take my time sightseeing today”), voice input (e.g., “I'm in a hurry, please make it simple”), facial images (e.g., face images captured by a camera), and biosensor data (e.g., heart rate, skin conductance response). The generation unit normalizes and extracts features from these input data using a preprocessing module (e.g., voice spectral conversion, extraction of facial feature vectors from facial images, calculation of statistical values from time-series biosensor data), and inputs them to the emotion estimation AI. The emotion estimation AI uses, for example, a multimodal Transformer or an architecture combining convolutional neural networks and recurrent neural networks, and outputs emotion labels (e.g., relaxed, hurried, excited) and emotion intensity scores (e.g., relaxation level 0.85, hurry level 0.10, excitement level 0.05) from the input features. Examples of AI input include a 128-dimensional facial feature vector, a 256-dimensional voice spectral vector, and a 10-dimensional biosensor statistical vector. Examples of AI output include “Emotion label: relaxed, score: 0.92” and “Emotion label: hurried, score: 0.78”. Based on these AI outputs, the generation unit dynamically switches the parameters of the 3D map generation AI. For example, when the relaxation level is high, a high-resolution, highly detailed 3D map is generated from various data sources such as satellite photographs, geographic information, detailed object attributes, and past weather data. When the hurry level is high, the 3D map is limited to the minimum necessary information (e.g., low-resolution satellite images, only major landmarks) to shorten the generation time. When the excitement level is high, visually impactful effects (e.g., colorful objects, dynamic light sources, special animations) are added to the 3D map. The 3D map generation AI may use a 3D convolutional neural network or an extended Transformer-based generative model to generate voxel grids or polygon meshes from input data. The AI model is pre-trained on teacher datasets of satellite images and geographic information, and uses loss functions such as terrain reproduction error and ground type classification error. The AI output is structured as 3D map data (e.g., voxel grid, polygon mesh, texture mapping information) and passed to subsequent character placement units and distribution units. Emotion-based generation optimization by AI is technically superior in that it simultaneously analyzes high-dimensional features from multiple modalities and autonomously determines generation strategies in real time according to the user's state, unlike subjective judgments by human operators or fixed generation rules. As a technical effect, the generation unit can realize 3D map generation tailored to the user's psychological state and intended use, achieve reduction of unnecessary computational resources, improve generation efficiency, and optimize user experience. Specific application fields include user state-adaptive 3D map generation for sightseeing guide apps, learner state-linked map generation for educational material creation, effect optimization map generation for video production support tools, and information presentation support according to patient state in medical settings.

The generation unit can refer to a user's past request history when generating a 3D map and select an appropriate generation method. For example, the generation unit selects the optimal generation method based on 3D maps previously generated by the user. The generation unit can also preferentially select highly relevant generation methods from the user's past request history. Furthermore, the generation unit can analyze the user's past request history and select the most efficient generation method. Thus, by referring to the user's past request history, the generation unit can select the optimal generation method. Some or all of the above-described processing in the generation unit may be performed using AI or without using AI. For example, the generation unit may input the user's past request history to the generative AI and have the generative AI execute the selection of the generation method. Specifically, the generation unit acquires request history data accumulated in chronological order for each user (e.g., request content text, reception date and time, type of generated map, generation time required, success/failure flag) from a database. The generation unit inputs these history data as feature vectors (e.g., embedded vectors of request content, one-hot vectors of day of week/time zone, category vectors of map type) to the AI model. The AI model may be a recurrent neural network (e.g., LSTM) or a Transformer-based history analysis model with self-attention mechanism, which excels at extracting time-series patterns. Examples of AI input include request content vectors for the past 30 requests (each 256 dimensions), generation time vectors (24 dimensions), and map type vectors (5 dimensions: sightseeing/education/video/game/other). Examples of AI output include “Recommended generation method: high-resolution voxel generation, confidence 0.87” and “Recommended generation category: educational map, score 0.92”. Based on the AI output, the generation unit automates subsequent processing such as algorithm selection for the 3D map generation AI, parameter setting, and switching of data acquisition modes (e.g., low-resolution generation at night). History analysis and generation optimization by AI is technically superior in that it analyzes multiple history patterns and usage trends in high-dimensional space and autonomously provides an optimized 3D map generation experience for each user, unlike human memory or simple history list display. As a technical effect, the generation unit can reduce the user's input burden, improve generation efficiency and satisfaction, and achieve reduction of unnecessary computational resources and shortening of generation time. Specific application fields include personalized generation for sightseeing guide apps, support for educational material creation, history-based map generation for video production tools, and efficiency generation for business systems.

The generation unit can perform filtering based on the user's current project or field of interest when generating a 3D map. For example, if the user wants to create a 3D map of a sightseeing spot, the generation unit prioritizes the generation of information related to sightseeing spots. If the user wants to create a 3D map for educational purposes, the generation unit can also prioritize the generation of information related to education. Furthermore, if the user wants to create a 3D map for video production, the generation unit can also prioritize the generation of information related to video production. Thus, by performing filtering based on the user's current project or field of interest, the generation unit can preferentially generate highly relevant 3D maps. Some or all of the above-described processing in the generation unit may be performed using AI or without using AI. For example, the generation unit may input the user's project or field of interest data to the generative AI and have the generative AI execute the filtering. Specifically, the generation unit acquires user profile data (e.g., name of ongoing project, field of interest tags, past usage history, selected category) and inputs these as feature vectors (e.g., one-hot vector of project type, embedded vector of field of interest) to the AI model. The AI model may be a multilayer perceptron suitable for category classification or a Transformer-based text classification model. Examples of AI input include “Project type: sightseeing map creation, field of interest: history/culture” and “Project type: educational material, field of interest: geography/science”. Examples of AI output include “Recommended generation category: sightseeing-related, score 0.93” and “Recommended generation category: education-related, score 0.88”. Based on the AI output, the generation unit executes subsequent processing such as prioritizing the display of only highly relevant information items on the generation screen, hiding unnecessary items, or dynamically switching the parameters of the generation algorithm. Project/field of interest filtering by AI is technically superior in that it autonomously optimizes the 3D map generation experience according to the user's current purpose and interest, unlike manual category selection or static UI design by humans. As a technical effect, the generation unit can realize 3D map generation that matches the user's purpose, improve generation efficiency and satisfaction, and reduce erroneous generation and irrelevant information. Specific application fields include project-based generation for sightseeing guide apps, support for educational material creation, category-based generation for video production tools, and purpose-based generation for business systems.

The generation unit can estimate a user's emotion and determine the priority of 3D maps to be generated based on the estimated emotion of the user. For example, when the user is nervous, the generation unit prioritizes the generation of important 3D maps. When the user is relaxed, the generation unit can also prioritize the generation of normal 3D maps. Furthermore, when the user is in a hurry, the generation unit can also prioritize the generation of urgent 3D maps. Thus, by determining the priority of 3D maps according to the user's emotion, the generation unit can preferentially generate important 3D maps. Emotion estimation is realized, for example, by using an emotion estimation function such as an emotion engine or a generative AI. The generative AI may be a text generation AI (e.g., LLM) or a multimodal generative AI, but is not limited to such examples. Some or all of the above-described processing in the generation unit may be performed using AI or without using AI. For example, the generation unit may input the user's emotion data to the generative AI and have the generative AI execute the determination of the priority of 3D maps. Specifically, the generation unit preprocesses emotion-related data obtained from the user (e.g., voice tone, facial images, emotional vocabulary in input sentences, heart rate) and inputs them to the emotion estimation AI. The emotion estimation AI uses a multimodal neural network to output emotion labels (e.g., nervous, relaxed, hurried) and emotion intensity scores from the input features. Examples of AI input include voice spectral vectors (128 dimensions), facial feature vectors (64 dimensions), and emotion scores of input sentences (1 dimension). Examples of AI output include “Emotion: nervous, score 0.91” and “Emotion: hurried, score 0.85”. Based on the AI output, the generation unit assigns priority scores to each generation task in the 3D map generation queue and preferentially generates and processes 3D maps with high importance or urgency. Subsequent processing may include highlighting high-priority 3D maps on the UI or automatically adjusting the generation order. Emotion-based priority determination by AI is technically superior in that it analyzes the user's state using multidimensional features and autonomously determines the optimal generation order in real time, unlike subjective judgments by human operators or fixed priority settings. As a technical effect, the generation unit can realize rapid generation of important 3D maps tailored to the user's psychological state, prevent overlooking urgent cases, and improve overall generation efficiency. Specific application fields include emergency map generation for sightseeing guide apps, priority generation of important teaching materials in educational settings, patient state-adaptive map generation in medical settings, and priority control in video production support tools.

The generation unit can preferentially generate highly relevant 3D maps by considering the user's geographic location information when generating a 3D map. For example, if the user is in a specific region, the generation unit prioritizes the generation of 3D maps related to that region. If the user is traveling, the generation unit can also prioritize the generation of 3D maps related to the travel destination. Furthermore, if the user is at home, the generation unit can also prioritize the generation of 3D maps related to the area around the home. Thus, by considering the user's geographic location information, the generation unit can preferentially generate highly relevant 3D maps. Some or all of the above-described processing in the generation unit may be performed using AI or without using AI. For example, the generation unit may input the user's geographic location information to the generative AI and have the generative AI execute the generation of the 3D map. Specifically, the generation unit inputs geographic location information obtained from the user's terminal, such as GPS coordinates (e.g., latitude 35.6812, longitude 139.7671), location accuracy, stay history, and movement speed, as feature vectors to the AI model. The AI model may be a neural network suitable for geographic clustering or location information classification (e.g., multilayer perceptron or Transformer-based model handling geographic features). Examples of AI input include “Current location: around Tokyo Station, in transit” and “Current location: home, stationary”. Examples of AI output include “Recommended generation category: Tokyo sightseeing-related, score 0.95” and “Recommended generation category: home area information, score 0.88”. Based on the AI output, the generation unit executes subsequent processing such as prioritizing the display of 3D map items related to the current location or destination on the generation screen, hiding unnecessary items, or dynamically switching the parameters of the generation algorithm. Geographic information-based filtering by AI is technically superior in that it autonomously optimizes the 3D map generation experience according to the user's current location and movement status, unlike manual location selection or static UI design by humans. As a technical effect, the generation unit can realize 3D map generation matching the user's current location or destination, improve generation efficiency and satisfaction, and achieve reduction of irrelevant information and advancement of location-linked services. Specific application fields include location-linked generation for sightseeing guide apps, destination map generation for travel support services, home area generation for community-based information services, and on-site generation for urban planning simulations.

The generation unit can analyze a user's social media activity when generating a 3D map and generate relevant 3D maps. For example, if the user posts about sightseeing spots on social media, the generation unit prioritizes the generation of 3D maps related to those sightseeing spots. If the user posts about education on social media, the generation unit can also prioritize the generation of 3D maps related to education. Furthermore, if the user posts about video production on social media, the generation unit can also prioritize the generation of 3D maps related to video production. Thus, by analyzing the user's social media activity, the generation unit can preferentially generate relevant 3D maps. Some or all of the above-described processing in the generation unit may be performed using AI or without using AI. For example, the generation unit may input the user's social media activity to the generative AI and have the generative AI execute the generation of the 3D map. Specifically, the generation unit inputs post data obtained from the user's linked social media accounts (e.g., text posts, image posts, hashtags, post date and time, number of likes) to a natural language processing AI or image analysis AI. The AI model may use a Transformer-based text classification model or an image feature extraction model to extract fields of interest or topic categories from the post content. Examples of AI input include “Post text: ‘Last week, I visited temples in Kyoto’”, “Post image: landscape photo of sightseeing spot”, and “Hashtag: #education #geography”. Examples of AI output include “Interest category: sightseeing, score 0.91” and “Interest category: education, score 0.87”. Based on the AI output, the generation unit executes subsequent processing such as prioritizing the display of 3D map items related to the user's latest field of interest on the generation screen, hiding unnecessary items, or dynamically switching the parameters of the generation algorithm. Social media activity analysis by AI is technically superior in that it analyzes the user's latest interests using high-dimensional features and optimizes the 3D map generation experience in real time, unlike manual post confirmation or static category selection by humans. As a technical effect, the generation unit can realize 3D map generation tailored to the user's latest interests, improve generation efficiency and satisfaction, and achieve reduction of irrelevant information and advancement of trend-linked services. Specific application fields include trend generation for sightseeing guide apps, support for educational material creation, topic-linked generation for video production tools, and field-of-interest generation for event guide services.

The placement unit can estimate a user's emotion and adjust the method of placing a character based on the estimated emotion of the user. For example, when the user is relaxed, the placement unit arranges the character in a leisurely manner. When the user is in a hurry, the placement unit can arrange the character efficiently. Furthermore, when the user is excited, the placement unit can arrange the character in a visually stimulating manner. Thus, by adjusting the method of placing the character according to the user's emotion, the placement unit enables more appropriate character placement. Emotion estimation is realized, for example, by using an emotion estimation function such as an emotion engine or a generative AI. The generative AI may be a text generation AI (e.g., LLM) or a multimodal generative AI, but is not limited to such examples. Some or all of the above-described processing in the placement unit may be performed using AI or without using AI. For example, the placement unit may input the user's emotion data to the generative AI and have the generative AI execute the adjustment of the character placement method. Specifically, the placement unit accepts various modalities as emotion-related data obtained from the user, such as text input (e.g., “I want to leisurely tour sightseeing spots today”), voice input (e.g., “I'm in a hurry, please guide me quickly”), facial images (e.g., face images captured by a camera), and biosensor data (e.g., heart rate, skin conductance response). The placement unit normalizes and extracts features from these input data using a preprocessing module (e.g., voice spectral conversion, extraction of facial feature vectors from facial images, calculation of statistical values from time-series biosensor data), and inputs them to the emotion estimation AI. The emotion estimation AI uses, for example, a multimodal Transformer or an architecture combining convolutional neural networks and recurrent neural networks, and outputs emotion labels (e.g., relaxed, hurried, excited) and emotion intensity scores (e.g., relaxation level 0.85, hurry level 0.10, excitement level 0.05) from the input features. Examples of AI input include a 128-dimensional facial feature vector, a 256-dimensional voice spectral vector, and a 10-dimensional biosensor statistical vector. Examples of AI output include “Emotion label: relaxed, score: 0.92” and “Emotion label: hurried, score: 0.78”. Based on these AI outputs, the placement unit dynamically switches the parameters of the character placement AI. For example, when the relaxation level is high, the character is distributed over a wide area and the movement pattern is set to be gentle. When the hurry level is high, the character is concentrated near major landmarks and assigned efficient actions such as guidance and navigation. When the excitement level is high, visually impactful characters, animations, and dynamic effects are added to the placement. The character placement AI may use a reinforcement learning agent or rule-based placement algorithm to simultaneously consider terrain information on the 3D map, the arrangement of existing objects, and user emotion parameters to determine optimal placement coordinates and action sequences. The AI output is structured data such as character ID, placement coordinates, and action scripts, for example, “Character ID: 001, coordinates: (120,45,10), action: start guidance”. In subsequent processing, these outputs are integrated with the 3D map data and passed to the distribution unit. Emotion-based placement optimization by AI is technically superior in that it simultaneously analyzes high-dimensional features from multiple modalities and autonomously determines placement strategies in real time according to the user's state, unlike subjective judgments by human operators or fixed placement rules. As a technical effect, the placement unit can realize character placement tailored to the user's psychological state and intended use, achieve reduction of unnecessary computational resources, improve placement efficiency, and optimize user experience. Specific application fields include user state-adaptive character placement for sightseeing guide apps, learner state-linked character placement for educational material creation, effect optimization character placement for video production support tools, and guidance character placement according to patient state in medical settings.

The placement unit can refer to a user's past request history when placing a character and select an appropriate placement method. For example, the placement unit selects the optimal placement method based on character placement methods previously used by the user. The placement unit can also preferentially select highly relevant placement methods from the user's past request history. Furthermore, the placement unit can analyze the user's past request history and select the most efficient placement method. Thus, by referring to the user's past request history, the placement unit can select the optimal character placement method. Some or all of the above-described processing in the placement unit may be performed using AI or without using AI. For example, the placement unit may input the user's past request history to the generative AI and have the generative AI execute the selection of the placement method. Specifically, the placement unit acquires request history data accumulated in chronological order for each user (e.g., request content text, reception date and time, type of placed character, placement coordinates, placement time required, success/failure flag) from a database. The placement unit inputs these history data as feature vectors (e.g., embedded vectors of request content, one-hot vectors of day of week/time zone, category vectors of character type, cluster ID of placement pattern) to the AI model. The AI model may be a recurrent neural network (e.g., LSTM) or a Transformer-based history analysis model with self-attention mechanism, which excels at extracting time-series patterns. Examples of AI input include request content vectors for the past 30 requests (each 256 dimensions), placement time vectors (24 dimensions), character type vectors (5 dimensions: guide/tourist/animal/education/other), and placement pattern vectors (10 dimensions). Examples of AI output include “Recommended placement method: landmark-concentrated placement, confidence 0.87” and “Recommended character type: guide, score 0.92”. Based on the AI output, the placement unit automates subsequent processing such as algorithm selection for the character placement AI, parameter setting, and switching of placement modes (e.g., static placement at night, dynamic placement during the day). History analysis and placement optimization by AI is technically superior in that it analyzes multiple history patterns and usage trends in high-dimensional space and autonomously provides an optimized character placement experience for each user, unlike human memory or simple history list display. As a technical effect, the placement unit can reduce the user's input burden, improve placement efficiency and satisfaction, and achieve reduction of unnecessary computational resources and shortening of placement time. Specific application fields include personalized placement for sightseeing guide apps, support for educational material creation, history-based character placement for video production tools, and efficiency placement for business systems.

The placement unit can perform filtering based on the user's current project or field of interest when placing a character. For example, if the user wants to create a 3D map of a sightseeing spot, the placement unit prioritizes the placement of characters related to sightseeing spots. If the user wants to create a 3D map for educational purposes, the placement unit can also prioritize the placement of characters related to education. Furthermore, if the user wants to create a 3D map for video production, the placement unit can also prioritize the placement of characters related to video production. Thus, by performing filtering based on the user's current project or field of interest, the placement unit can preferentially place highly relevant characters. Some or all of the above-described processing in the placement unit may be performed using AI or without using AI. For example, the placement unit may input the user's project or field of interest data to the generative AI and have the generative AI execute the filtering. Specifically, the placement unit acquires user profile data (e.g., name of ongoing project, field of interest tags, past usage history, selected category) and inputs these as feature vectors (e.g., one-hot vector of project type, embedded vector of field of interest) to the AI model. The AI model may be a multilayer perceptron suitable for category classification or a Transformer-based text classification model. Examples of AI input include “Project type: sightseeing map creation, field of interest: history/culture” and “Project type: educational material, field of interest: geography/science”. Examples of AI output include “Recommended placement category: sightseeing-related character, score 0.93” and “Recommended placement category: education-related character, score 0.88”. Based on the AI output, the placement unit executes subsequent processing such as prioritizing the display of only highly relevant character items on the placement screen, hiding unnecessary items, or dynamically switching the parameters of the placement algorithm. Project/field of interest filtering by AI is technically superior in that it autonomously optimizes the character placement experience according to the user's current purpose and interest, unlike manual category selection or static UI design by humans. As a technical effect, the placement unit can realize character placement that matches the user's purpose, improve placement efficiency and satisfaction, and reduce erroneous placement and irrelevant characters. Specific application fields include project-based character placement for sightseeing guide apps, support for educational material creation, category-based character placement for video production tools, and purpose-based character placement for business systems.

The placement unit can estimate a user's emotion and determine the priority of characters to be placed based on the estimated emotion of the user. For example, when the user is nervous, the placement unit prioritizes the placement of important characters. When the user is relaxed, the placement unit can also prioritize the placement of normal characters. Furthermore, when the user is in a hurry, the placement unit can also prioritize the placement of urgent characters. Thus, by determining the priority of characters according to the user's emotion, the placement unit can preferentially place important characters. Emotion estimation is realized, for example, by using an emotion estimation function such as an emotion engine or a generative AI. The generative AI may be a text generation AI (e.g., LLM) or a multimodal generative AI, but is not limited to such examples. Some or all of the above-described processing in the placement unit may be performed using AI or without using AI. For example, the placement unit may input the user's emotion data to the generative AI and have the generative AI execute the determination of the priority of characters. Specifically, the placement unit preprocesses emotion-related data obtained from the user (e.g., voice tone, facial images, emotional vocabulary in input sentences, heart rate) and inputs them to the emotion estimation AI. The emotion estimation AI uses a multimodal neural network to output emotion labels (e.g., nervous, relaxed, hurried) and emotion intensity scores from the input features. Examples of AI input include voice spectral vectors (128 dimensions), facial feature vectors (64 dimensions), and emotion scores of input sentences (1 dimension). Examples of AI output include “Emotion: nervous, score 0.91” and “Emotion: hurried, score 0.85”. Based on the AI output, the placement unit assigns priority scores to each character in the character placement queue and preferentially places and processes characters with high importance or urgency. Subsequent processing may include highlighting high-priority characters on the UI or automatically adjusting the placement order. Emotion-based priority determination by AI is technically superior in that it analyzes the user's state using multidimensional features and autonomously determines the optimal placement order in real time, unlike subjective judgments by human operators or fixed priority settings. As a technical effect, the placement unit can realize rapid placement of important characters tailored to the user's psychological state, prevent overlooking urgent cases, and improve overall placement efficiency. Specific application fields include emergency character placement for sightseeing guide apps, priority placement of important teaching materials in educational settings, patient state-adaptive character placement in medical settings, and priority control in video production support tools.

The placement unit can preferentially place highly relevant characters by considering the user's geographic location information when placing a character. For example, if the user is in a specific region, the placement unit prioritizes the placement of characters related to that region. If the user is traveling, the placement unit can also prioritize the placement of characters related to the travel destination. Furthermore, if the user is at home, the placement unit can also prioritize the placement of characters related to the area around the home. Thus, by considering the user's geographic location information, the placement unit can preferentially place highly relevant characters. Some or all of the above-described processing in the placement unit may be performed using AI or without using AI. For example, the placement unit may input the user's geographic location information to the generative AI and have the generative AI execute the placement of the character. Specifically, the placement unit inputs geographic location information obtained from the user's terminal, such as GPS coordinates (e.g., latitude 35.6812, longitude 139.7671), location accuracy, stay history, and movement speed, as feature vectors to the AI model. The AI model may be a neural network suitable for geographic clustering or location information classification (e.g., multilayer perceptron or Transformer-based model handling geographic features). Examples of AI input include “Current location: around Tokyo Station, in transit” and “Current location: home, stationary”. Examples of AI output include “Recommended placement category: Tokyo sightseeing-related character, score 0.95” and “Recommended placement category: home area character, score 0.88”. Based on the AI output, the placement unit executes subsequent processing such as prioritizing the display of character items related to the current location or destination on the placement screen, hiding unnecessary items, or dynamically switching the parameters of the placement algorithm. Geographic information-based filtering by AI is technically superior in that it autonomously optimizes the character placement experience according to the user's current location and movement status, unlike manual location selection or static UI design by humans. As a technical effect, the placement unit can realize character placement matching the user's current location or destination, improve placement efficiency and satisfaction, and achieve reduction of irrelevant characters and advancement of location-linked services. Specific application fields include location-linked character placement for sightseeing guide apps, destination character placement for travel support services, home area character placement for community-based information services, and on-site character placement for urban planning simulations.

The placement unit can analyze a user's social media activity when placing a character and place relevant characters. For example, if the user posts about sightseeing spots on social media, the placement unit prioritizes the placement of characters related to those sightseeing spots. If the user posts about education on social media, the placement unit can also prioritize the placement of characters related to education. Furthermore, if the user posts about video production on social media, the placement unit can also prioritize the placement of characters related to video production. Thus, by analyzing the user's social media activity, the placement unit can preferentially place relevant characters. Some or all of the above-described processing in the placement unit may be performed using AI or without using AI. For example, the placement unit may input the user's social media activity to the generative AI and have the generative AI execute the placement of the character. Specifically, the placement unit inputs post data obtained from the user's linked social media accounts (e.g., text posts, image posts, hashtags, post date and time, number of likes) to a natural language processing AI or image analysis AI. The AI model may use a Transformer-based text classification model or an image feature extraction model to extract fields of interest or topic categories from the post content. Examples of AI input include “Post text: ‘Last week, I visited temples in Kyoto’”, “Post image: landscape photo of sightseeing spot”, and “Hashtag: #education #geography”. Examples of AI output include “Interest category: sightseeing, score 0.91” and “Interest category: education, score 0.87”. Based on the AI output, the placement unit executes subsequent processing such as prioritizing the display of character items related to the user's latest field of interest on the placement screen, hiding unnecessary items, or dynamically switching the parameters of the placement algorithm. Social media activity analysis by AI is technically superior in that it analyzes the user's latest interests using high-dimensional features and optimizes the character placement experience in real time, unlike manual post confirmation or static category selection by humans. As a technical effect, the placement unit can realize character placement tailored to the user's latest interests, improve placement efficiency and satisfaction, and achieve reduction of irrelevant characters and advancement of trend-linked services. Specific application fields include trend character placement for sightseeing guide apps, support for educational material creation, topic-linked character placement for video production tools, and field-of-interest character placement for event guide services.

The distribution unit can estimate a user's emotion and adjust the method of distribution based on the estimated emotion of the user. For example, when the user is relaxed, the distribution unit distributes at a leisurely pace. When the user is in a hurry, the distribution unit can distribute quickly. Furthermore, when the user is excited, the distribution unit can distribute with visually stimulating effects. Thus, by adjusting the method of distribution according to the user's emotion, the distribution unit enables more appropriate distribution. Emotion estimation is realized, for example, by using an emotion estimation function such as an emotion engine or a generative AI. The generative AI may be a text generation AI (e.g., LLM) or a multimodal generative AI, but is not limited to such examples. Some or all of the above-described processing in the distribution unit may be performed using AI or without using AI. For example, the distribution unit may input the user's emotion data to the generative AI and have the generative AI execute the adjustment of the distribution method. Specifically, the distribution unit accepts various modalities as emotion-related data obtained from the user, such as text input (e.g., “I want to leisurely enjoy sightseeing today”), voice input (e.g., “I'm in a hurry, please guide me quickly”), facial images (e.g., face images captured by a camera), and biosensor data (e.g., heart rate, skin conductance response). The distribution unit normalizes and extracts features from these input data using a preprocessing module (e.g., voice spectral conversion, extraction of facial feature vectors from facial images, calculation of statistical values from time-series biosensor data), and inputs them to the emotion estimation AI. The emotion estimation AI uses, for example, a multimodal Transformer or an architecture combining convolutional neural networks and recurrent neural networks, and outputs emotion labels (e.g., relaxed, hurried, excited) and emotion intensity scores (e.g., relaxation level 0.85, hurry level 0.10, excitement level 0.05) from the input features. Examples of AI input include a 128-dimensional facial feature vector, a 256-dimensional voice spectral vector, and a 10-dimensional biosensor statistical vector. Examples of AI output include “Emotion label: relaxed, score: 0.92” and “Emotion label: hurried, score: 0.78”. Based on these AI outputs, the distribution unit dynamically switches the parameters of the distribution AI. For example, when the relaxation level is high, the distribution speed is set low, buffering for video and audio is extended, and stable distribution focused on user experience is performed. When the hurry level is high, the distribution speed is maximized, low-latency protocols (e.g., UDP-based streaming) are selected, and only the minimum necessary data is preferentially transmitted. When the excitement level is high, dynamic effects (e.g., colorful transitions, dynamic animations) are added to the distributed video to enhance visual impact. The distribution AI may use a reinforcement learning agent or rule-based distribution optimization algorithm to simultaneously consider network bandwidth, terminal performance, and user emotion parameters to determine the optimal distribution strategy. The AI output is structured data such as distribution speed setting, effect application flag, buffer size, and protocol selection, for example, “Distribution speed: 2 Mbps, effect: ON, buffer: 5 seconds”. In subsequent processing, the distribution unit automatically adjusts the parameters of the distribution engine according to the AI output and optimizes data transmission to the user's terminal. Emotion-based distribution optimization by AI is technically superior in that it simultaneously analyzes high-dimensional features from multiple modalities and autonomously determines distribution strategies in real time according to the user's state, unlike subjective judgments by human operators or fixed distribution rules. As a technical effect, the distribution unit can realize distribution tailored to the user's psychological state and intended use, achieve reduction of unnecessary communication resources, improve distribution efficiency, and optimize user experience. Specific application fields include user state-adaptive distribution for sightseeing guide apps, learner state-linked distribution for educational material distribution, effect optimization distribution for video production support tools, and information distribution support according to patient state in medical settings.

The distribution unit can refer to a user's past request history when distributing and select an appropriate distribution method. For example, the distribution unit selects the optimal distribution method based on content previously distributed by the user. The distribution unit can also preferentially select highly relevant distribution methods from the user's past request history. Furthermore, the distribution unit can analyze the user's past request history and select the most efficient distribution method. Thus, by referring to the user's past request history, the distribution unit can select the optimal distribution method. Some or all of the above-described processing in the distribution unit may be performed using AI or without using AI. For example, the distribution unit may input the user's past request history to the generative AI and have the generative AI execute the selection of the distribution method. Specifically, the distribution unit acquires request history data accumulated in chronological order for each user (e.g., request content text, distribution date and time, type of distribution method, distribution time required, success/failure flag) from a database. The distribution unit inputs these history data as feature vectors (e.g., embedded vectors of request content, one-hot vectors of day of week/time zone, category vectors of distribution method type) to the AI model. The AI model may be a recurrent neural network (e.g., LSTM) or a Transformer-based history analysis model with self-attention mechanism, which excels at extracting time-series patterns. Examples of AI input include request content vectors for the past 30 requests (each 256 dimensions), distribution time vectors (24 dimensions), and distribution method type vectors (5 dimensions: streaming/download/batch/live/other). Examples of AI output include “Recommended distribution method: streaming, confidence 0.87” and “Recommended distribution method: batch distribution, score 0.92”. Based on the AI output, the distribution unit automates subsequent processing such as algorithm selection for the distribution engine, parameter setting, and switching of distribution modes (e.g., batch distribution at night, live distribution during the day). History analysis and distribution optimization by AI is technically superior in that it analyzes multiple history patterns and usage trends in high-dimensional space and autonomously provides an optimized distribution experience for each user, unlike human memory or simple history list display. As a technical effect, the distribution unit can reduce the user's input burden, improve distribution efficiency and satisfaction, and achieve reduction of unnecessary communication resources and shortening of distribution time. Specific application fields include personalized distribution for sightseeing guide apps, support for educational material distribution, history-based distribution for video production tools, and efficiency distribution for business systems.

The distribution unit can perform filtering based on the user's current project or field of interest when distributing. For example, if the user wants to distribute a 3D map of a sightseeing spot, the distribution unit prioritizes the distribution of information related to sightseeing spots. If the user wants to distribute a 3D map for educational purposes, the distribution unit can also prioritize the distribution of information related to education. Furthermore, if the user wants to distribute a 3D map for video production, the distribution unit can also prioritize the distribution of information related to video production. Thus, by performing filtering based on the user's current project or field of interest, the distribution unit can preferentially distribute highly relevant content. Some or all of the above-described processing in the distribution unit may be performed using AI or without using AI. For example, the distribution unit may input the user's project or field of interest data to the generative AI and have the generative AI execute the filtering. Specifically, the distribution unit acquires user profile data (e.g., name of ongoing project, field of interest tags, past usage history, selected category) and inputs these as feature vectors (e.g., one-hot vector of project type, embedded vector of field of interest) to the AI model. The AI model may be a multilayer perceptron suitable for category classification or a Transformer-based text classification model. Examples of AI input include “Project type: sightseeing map distribution, field of interest: history/culture” and “Project type: educational material distribution, field of interest: geography/science”. Examples of AI output include “Recommended distribution category: sightseeing-related, score 0.93” and “Recommended distribution category: education-related, score 0.88”. Based on the AI output, the distribution unit executes subsequent processing such as prioritizing the display of only highly relevant content items on the distribution screen, hiding unnecessary items, or dynamically switching the parameters of the distribution algorithm. Project/field of interest filtering by AI is technically superior in that it autonomously optimizes the distribution experience according to the user's current purpose and interest, unlike manual category selection or static UI design by humans. As a technical effect, the distribution unit can realize content distribution that matches the user's purpose, improve distribution efficiency and satisfaction, and reduce erroneous distribution and irrelevant content. Specific application fields include project-based distribution for sightseeing guide apps, support for educational material distribution, category-based distribution for video production tools, and purpose-based distribution for business systems.

The distribution unit can estimate a user's emotion and determine the priority of content to be distributed based on the estimated emotion of the user. For example, when the user is nervous, the distribution unit prioritizes the distribution of important content. When the user is relaxed, the distribution unit can also prioritize the distribution of normal content. Furthermore, when the user is in a hurry, the distribution unit can also prioritize the distribution of urgent content. Thus, by determining the priority of content according to the user's emotion, the distribution unit can preferentially distribute important content. Emotion estimation is realized, for example, by using an emotion estimation function such as an emotion engine or a generative AI. The generative AI may be a text generation AI (e.g., LLM) or a multimodal generative AI, but is not limited to such examples. Some or all of the above-described processing in the distribution unit may be performed using AI or without using AI. For example, the distribution unit may input the user's emotion data to the generative AI and have the generative AI execute the determination of the priority of content. Specifically, the distribution unit preprocesses emotion-related data obtained from the user (e.g., voice tone, facial images, emotional vocabulary in input sentences, heart rate) and inputs them to the emotion estimation AI. The emotion estimation AI uses a multimodal neural network to output emotion labels (e.g., nervous, relaxed, hurried) and emotion intensity scores from the input features. Examples of AI input include voice spectral vectors (128 dimensions), facial feature vectors (64 dimensions), and emotion scores of input sentences (1 dimension). Examples of AI output include “Emotion: nervous, score 0.91” and “Emotion: hurried, score 0.85”. Based on the AI output, the distribution unit assigns priority scores to each content in the distribution queue and preferentially distributes and processes content with high importance or urgency. Subsequent processing may include highlighting high-priority content on the UI or automatically adjusting the distribution order. Emotion-based priority determination by AI is technically superior in that it analyzes the user's state using multidimensional features and autonomously determines the optimal distribution order in real time, unlike subjective judgments by human operators or fixed priority settings. As a technical effect, the distribution unit can realize rapid distribution of important content tailored to the user's psychological state, prevent overlooking urgent cases, and improve overall distribution efficiency. Specific application fields include emergency content distribution for sightseeing guide apps, priority distribution of important teaching materials in educational settings, patient state-adaptive distribution in medical settings, and priority control in video production support tools.

The distribution unit can preferentially distribute highly relevant content by considering the user's geographic location information when distributing. For example, if the user is in a specific region, the distribution unit prioritizes the distribution of content related to that region. If the user is traveling, the distribution unit can also prioritize the distribution of content related to the travel destination. Furthermore, if the user is at home, the distribution unit can also prioritize the distribution of content related to the area around the home. Thus, by considering the user's geographic location information, the distribution unit can preferentially distribute highly relevant content. Some or all of the above-described processing in the distribution unit may be performed using AI or without using AI. For example, the distribution unit may input the user's geographic location information to the generative AI and have the generative AI execute the distribution of content. Specifically, the distribution unit inputs geographic location information obtained from the user's terminal, such as GPS coordinates (e.g., latitude 35.6812, longitude 139.7671), location accuracy, stay history, and movement speed, as feature vectors to the AI model. The AI model may be a neural network suitable for geographic clustering or location information classification (e.g., multilayer perceptron or Transformer-based model handling geographic features). Examples of AI input include “Current location: around Tokyo Station, in transit” and “Current location: home, stationary”. Examples of AI output include “Recommended distribution category: Tokyo sightseeing-related, score 0.95” and “Recommended distribution category: home area information, score 0.88”. Based on the AI output, the distribution unit executes subsequent processing such as prioritizing the display of content items related to the current location or destination on the distribution screen, hiding unnecessary items, or dynamically switching the parameters of the distribution algorithm. Geographic information-based filtering by AI is technically superior in that it autonomously optimizes the distribution experience according to the user's current location and movement status, unlike manual location selection or static UI design by humans. As a technical effect, the distribution unit can realize content distribution matching the user's current location or destination, improve distribution efficiency and satisfaction, and achieve reduction of irrelevant content and advancement of location-linked services. Specific application fields include location-linked distribution for sightseeing guide apps, destination distribution for travel support services, home area distribution for community-based information services, and on-site distribution for urban planning simulations.

The distribution unit can analyze a user's social media activity when distributing and distribute relevant content. For example, if the user posts about sightseeing spots on social media, the distribution unit prioritizes the distribution of content related to those sightseeing spots. If the user posts about education on social media, the distribution unit can also prioritize the distribution of content related to education. Furthermore, if the user posts about video production on social media, the distribution unit can also prioritize the distribution of content related to video production. Thus, by analyzing the user's social media activity, the distribution unit can preferentially distribute relevant content. Some or all of the above-described processing in the distribution unit may be performed using AI or without using AI. For example, the distribution unit may input the user's social media activity to the generative AI and have the generative AI execute the distribution of content. Specifically, the distribution unit inputs post data obtained from the user's linked social media accounts (e.g., text posts, image posts, hashtags, post date and time, number of likes) to a natural language processing AI or image analysis AI. The AI model may use a Transformer-based text classification model or an image feature extraction model to extract fields of interest or topic categories from the post content. Examples of AI input include “Post text: ‘Last week, I visited temples in Kyoto’”, “Post image: landscape photo of sightseeing spot”, and “Hashtag: #education #geography”. Examples of AI output include “Interest category: sightseeing, score 0.91” and “Interest category: education, score 0.87”. Based on the AI output, the distribution unit executes subsequent processing such as prioritizing the display of content items related to the user's latest field of interest on the distribution screen, hiding unnecessary items, or dynamically switching the parameters of the distribution algorithm. Social media activity analysis by AI is technically superior in that it analyzes the user's latest interests using high-dimensional features and optimizes the distribution experience in real time, unlike manual post confirmation or static category selection by humans. As a technical effect, the distribution unit can realize content distribution tailored to the user's latest interests, improve distribution efficiency and satisfaction, and achieve reduction of irrelevant content and advancement of trend-linked services. Specific application fields include trend distribution for sightseeing guide apps, support for educational material distribution, topic-linked distribution for video production tools, and field-of-interest distribution for event guide services.

The system according to the embodiment is not limited to the above examples, and various modifications are possible, for example, as follows. Specifically, the present system can flexibly change the architecture of AI models, data flow, input/output specifications, parameter settings, learning methods, hardware configuration, and other aspects in each component (reception unit, collection unit, generation unit, placement unit, distribution unit). For example, the reception unit can realize multimodal request reception by combining multiple AI modules (speech recognition AI, image recognition AI, time-series analysis AI, etc.) in addition to natural language understanding by a single large language model. The collection unit can integrate real-time data streams from distributed databases in the cloud and edge devices, and optimize data collection strategies dynamically using AI. The generation unit can select different generative AIs such as 3D convolutional neural networks, extended Transformers, and graph neural networks, and switch generation algorithms according to the application and user state. The placement unit can combine multiple placement strategies such as reinforcement learning agents, rule-based placement algorithms, and evolutionary optimization methods, and automatically select the optimal placement method according to user experience and system load. The distribution unit can dynamically switch distribution methods such as streaming, batch distribution, and live distribution according to network bandwidth, terminal performance, and user state, and realize distribution parameter optimization by AI. Furthermore, the AI models in each unit can adopt various learning methods such as supervised learning, reinforcement learning, transfer learning, and self-supervised learning, and can continuously improve accuracy through data augmentation and online learning. As for hardware configuration, parallel computing clusters using GPUs, FPGA accelerators, and edge AI devices can be combined to optimize processing speed, power consumption, and cost requirements. As a technical effect, the present system can quickly respond to changes in application and operating environment due to the flexible changeability of components and AI models, and can greatly improve the scalability, maintainability, and optimization performance of the entire system. Specific application fields include multilingual and multicultural support for sightseeing guide apps, curriculum adaptation for educational material creation support, expansion of production variation for video production tools, patient state-linked information presentation in medical settings, and large-scale data linkage for urban planning simulations, enabling application in a wide range of fields.

The reception unit can analyze a user's past behavior history when receiving a user's request and propose an optimal request reception method. For example, the reception unit preferentially displays request formats (text, voice, etc.) frequently used by the user in the past. The reception unit can also automatically propose related requests based on the content of requests previously made by the user. Furthermore, the reception unit can analyze the user's past behavior patterns and propose request reception methods suitable for specific time zones. Thus, by utilizing the user's past behavior history, the reception unit can realize more efficient and personalized request reception. Specifically, the reception unit acquires behavior history data accumulated in chronological order for each user (e.g., request type, input format, reception date and time, terminal used, success/failure flag) from a database, and inputs these as feature vectors (e.g., one-hot vector of request type, category vector of input format, sine/cosine converted vector of time zone) to the AI model. The AI model may be a recurrent neural network (LSTM) or a Transformer-based history analysis model with self-attention mechanism, which excels at extracting time-series patterns. Examples of AI input include request format vectors for the past 30 requests (each 10 dimensions), reception time vectors (24 dimensions), and terminal type vectors (5 dimensions: smartphone/PC/tablet/voice terminal/other). Examples of AI output include “Recommended reception format: voice, confidence 0.89”, “Recommended request: sightseeing guide, score 0.92”, and “Recommended reception time zone: morning, score 0.85”. Based on the AI output, the reception unit executes subsequent processing such as prioritizing the display of the input format most convenient for the user on the reception screen, automatically proposing highly relevant request items, hiding unnecessary items, or dynamically switching input guides and help. Behavior history analysis and reception optimization by AI is technically superior in that it analyzes multiple history patterns and usage trends in high-dimensional space and autonomously provides an optimized reception experience for each user, unlike human memory or simple history list display. As a technical effect, the reception unit can reduce the user's input burden, improve reception efficiency and satisfaction, and achieve reduction of unnecessary or erroneous input and shortening of reception time. Specific application fields include personalized reception for sightseeing guide apps, support for educational material creation, history-based reception for video production tools, and efficiency reception for business systems.

The collection unit can determine the priority of data collection based on the user's current project and field of interest. For example, if the user wants to create a 3D map of a tourist spot, the collection unit prioritizes the collection of data related to tourist spots. Additionally, if the user wants to create a 3D map for educational purposes, the collection unit can prioritize the collection of data related to education. Furthermore, if the user wants to create a 3D map for video production, the collection unit can prioritize the collection of data related to video production. In this way, the collection unit can efficiently collect highly relevant data based on the user's current project and field of interest. Specifically, the collection unit acquires user profile data (e.g., current project name, field of interest tags, past usage history, selected category) and inputs these as feature vectors (e.g., one-hot vectors for project type, embedding vectors for field of interest) into an AI model. As the AI model, a multilayer perceptron or Transformer-based text classification model suitable for category classification and priority estimation can be used. Examples of AI input include “Project type: Tourist map creation, Field of interest: History/Culture” and “Project type: Educational material, Field of interest: Geography/Science.” Examples of AI output include “Recommended collection category: Tourist-related, Priority 0.93” and “Recommended collection category: Education-related, Priority 0.88.” Based on the AI output, the collection unit executes subsequent processing such as prioritizing the display of highly relevant data items on the collection screen, hiding unnecessary items, or dynamically switching the parameters of data acquisition API calls. Priority determination based on project and field of interest by AI is technically superior in that it autonomously optimizes the data collection experience according to the user's current purpose and interest, unlike manual category selection or static UI design. As a technical effect, the collection unit realizes data collection that matches the user's purpose, improves collection efficiency and satisfaction, and reduces erroneous or irrelevant data. Specific application fields include project-based data collection for tourist guide apps, support for educational material creation, category-based data acquisition for video production tools, and purpose-based data collection for business systems.

The generation unit can estimate the user's emotion and adjust the method of generating a 3D map based on the estimated emotion of the user. For example, if the user is relaxed, a detailed 3D map is generated. Additionally, if the user is in a hurry, the generation unit can generate a 3D map containing only the minimum necessary information. Furthermore, if the user is excited, the generation unit can generate a 3D map with visually stimulating effects. In this way, the generation unit can adjust the method of generating a 3D map according to the user's emotion to generate a more appropriate 3D map. Specifically, the generation unit accepts various modalities of emotion-related data obtained from the user, such as text input (e.g., “I want to take my time to see the tourist spot today”), voice input (e.g., “I'm in a hurry, so please make it simple”), facial images (e.g., face images captured by a camera), and biometric sensor data (e.g., heart rate, skin conductance). The generation unit normalizes and extracts features from these input data using a preprocessing module (e.g., voice spectral conversion, extraction of facial feature vectors from images, calculation of statistical values from time-series biometric data), and inputs them into an emotion estimation AI. The emotion estimation AI, for example, uses a multimodal Transformer or an architecture combining convolutional neural networks and recurrent neural networks, and outputs emotion labels (e.g., relaxed, hurried, excited) and emotion intensity scores (e.g., relaxation level 0.85, hurry level 0.10, excitement level 0.05) from the input features. Examples of AI input include a 128-dimensional facial feature vector, a 256-dimensional voice spectral vector, and a 10-dimensional biometric sensor statistical vector. Examples of AI output include “Emotion label: Relaxed, Score: 0.92” and “Emotion label: Hurried, Score: 0.78.” Based on these AI outputs, the generation unit dynamically switches the parameters of the 3D map generation AI. For example, when the relaxation level is high, a high-resolution, highly detailed 3D map is generated from various data sources such as satellite photographs, geographic information, detailed object attributes, and past weather data. When the hurry level is high, the 3D map is limited to the minimum necessary information (e.g., low-resolution satellite images, only major landmarks) to shorten generation time. When the excitement level is high, visually impactful effects (e.g., colorful objects, dynamic light sources, special animations) are added to the 3D map. As the 3D map generation AI, a 3D convolutional neural network or an extended Transformer-based generative model is used to generate voxel grids or polygon meshes from input data. The AI model is pre-trained on a teacher dataset of satellite images and geographic information, and uses loss functions such as terrain reproduction error and land type classification error. The AI output is structured as 3D map data (e.g., voxel grid, polygon mesh, texture mapping information) and passed to subsequent character placement and distribution units. Emotion-based generation optimization by AI is technically superior in that it can autonomously and in real time determine generation strategies according to the user's state by simultaneously analyzing high-dimensional features from multiple modalities, unlike subjective judgment by human operators or fixed generation rules. As a technical effect, the generation unit realizes 3D map generation tailored to the user's psychological state and purpose of use, achieves reduction of unnecessary computational resources, improves generation efficiency, and optimizes user experience. Specific application fields include user state-adaptive 3D map generation for tourist guide apps, learner state-linked map generation for educational material creation, effect optimization map generation for video production support tools, and information presentation support according to patient state in medical settings.

The placement unit can estimate the user's emotion and adjust the method of placing a character based on the estimated emotion of the user. For example, if the user is relaxed, the character is placed in a leisurely manner. Additionally, if the user is in a hurry, the placement unit can efficiently place the character. Furthermore, if the user is excited, the placement unit can arrange the character in a visually stimulating manner. In this way, the placement unit can adjust the method of placing a character according to the user's emotion, enabling more appropriate character placement. Specifically, the placement unit accepts various modalities of emotion-related data obtained from the user, such as text input (e.g., “I want to leisurely tour the tourist spots today”), voice input (e.g., “I'm in a hurry, so please guide me quickly”), facial images (e.g., face images captured by a camera), and biometric sensor data (e.g., heart rate, skin conductance). The placement unit normalizes and extracts features from these input data using a preprocessing module (e.g., voice spectral conversion, extraction of facial feature vectors from images, calculation of statistical values from time-series biometric data), and inputs them into an emotion estimation AI. The emotion estimation AI, for example, uses a multimodal Transformer or an architecture combining convolutional neural networks and recurrent neural networks, and outputs emotion labels (e.g., relaxed, hurried, excited) and emotion intensity scores (e.g., relaxation level 0.85, hurry level 0.10, excitement level 0.05) from the input features. Examples of AI input include a 128-dimensional facial feature vector, a 256-dimensional voice spectral vector, and a 10-dimensional biometric sensor statistical vector. Examples of AI output include “Emotion label: Relaxed, Score: 0.92” and “Emotion label: Hurried, Score: 0.78.” Based on these AI outputs, the placement unit dynamically switches the parameters of the character placement AI. For example, when the relaxation level is high, characters are distributed widely and their movement patterns are set gently. When the hurry level is high, characters are concentrated near major landmarks and assigned efficient actions such as guidance and navigation. When the excitement level is high, visually impactful characters, animations, and dynamic effects are added to the placement. As the character placement AI, a reinforcement learning agent or rule-based placement algorithm is used to determine optimal placement coordinates and action sequences by simultaneously considering terrain information on the 3D map, the status of existing object placements, and user emotion parameters. The AI output is structured data such as character ID, placement coordinates, and action scripts, for example, “Character ID: 001, Coordinates: (120,45,10), Action: Start guidance.” As a subsequent process, these outputs are integrated with the 3D map data and passed to the distribution unit. Emotion-based placement optimization by AI is technically superior in that it can autonomously and in real time determine placement strategies according to the user's state by simultaneously analyzing high-dimensional features from multiple modalities, unlike subjective judgment by human operators or fixed placement rules. As a technical effect, the placement unit realizes character placement tailored to the user's psychological state and purpose of use, achieves reduction of unnecessary computational resources, improves placement efficiency, and optimizes user experience. Specific application fields include user state-adaptive character placement for tourist guide apps, learner state-linked character placement for educational material creation, effect optimization character placement for video production support tools, and guidance character placement according to patient state in medical settings.

The distribution unit can estimate the user's emotion and adjust the method of distribution based on the estimated emotion of the user. For example, if the user is relaxed, distribution is performed at a leisurely pace. Additionally, if the user is in a hurry, the distribution unit can distribute quickly. Furthermore, if the user is excited, the distribution unit can add visually stimulating effects to the distribution. In this way, the distribution unit can adjust the method of distribution according to the user's emotion, enabling more appropriate distribution. Specifically, the distribution unit accepts various modalities of emotion-related data obtained from the user, such as text input (e.g., “I want to leisurely enjoy the tourist spot today”), voice input (e.g., “I'm in a hurry, so please guide me quickly”), facial images (e.g., face images captured by a camera), and biometric sensor data (e.g., heart rate, skin conductance). The distribution unit normalizes and extracts features from these input data using a preprocessing module (e.g., voice spectral conversion, extraction of facial feature vectors from images, calculation of statistical values from time-series biometric data), and inputs them into an emotion estimation AI. The emotion estimation AI, for example, uses a multimodal Transformer or an architecture combining convolutional neural networks and recurrent neural networks, and outputs emotion labels (e.g., relaxed, hurried, excited) and emotion intensity scores (e.g., relaxation level 0.85, hurry level 0.10, excitement level 0.05) from the input features. Examples of AI input include a 128-dimensional facial feature vector, a 256-dimensional voice spectral vector, and a 10-dimensional biometric sensor statistical vector. Examples of AI output include “Emotion label: Relaxed, Score: 0.92” and “Emotion label: Hurried, Score: 0.78.” Based on these AI outputs, the distribution unit dynamically switches the parameters of the distribution AI. For example, when the relaxation level is high, the distribution speed is set low, video and audio buffering is extended, and stable distribution focused on user experience is performed. When the hurry level is high, the distribution speed is maximized, a low-latency protocol (e.g., UDP-based streaming) is selected, and only the minimum necessary data is prioritized for transmission. When the excitement level is high, dynamic effects (e.g., colorful transitions, dynamic animations) are added to the distributed video to enhance visual impact. As the distribution AI, a reinforcement learning agent for distribution control or a rule-based distribution optimization algorithm is used to determine the optimal distribution strategy by simultaneously considering network bandwidth, device performance, and user emotion parameters. The AI output is structured data such as distribution speed settings, effect application flags, buffer size, and protocol selection, for example, “Distribution speed: 2 Mbps, Effect: ON, Buffer: 5 seconds.” As a subsequent process, the distribution unit automatically adjusts the parameters of the distribution engine according to the AI output and optimizes data transmission to the user terminal. Emotion-based distribution optimization by AI is technically superior in that it can autonomously and in real time determine distribution strategies according to the user's state by simultaneously analyzing high-dimensional features from multiple modalities, unlike subjective judgment by human operators or fixed distribution rules. As a technical effect, the distribution unit realizes distribution tailored to the user's psychological state and purpose of use, achieves reduction of unnecessary communication resources, improves distribution efficiency, and optimizes user experience. Specific application fields include user state-adaptive distribution for tourist guide apps, learner state-linked distribution for educational material delivery, effect optimization distribution for video production support tools, and information distribution support according to patient state in medical settings.

The reception unit can adjust the method of receiving a request by considering the user's geographic location information. For example, if the user is in a specific region, requests related to that region are preferentially received. Additionally, if the user is traveling, requests related to the travel destination can be preferentially received. Furthermore, if the user is at home, requests related to the vicinity of the home can be preferentially received. In this way, the reception unit can preferentially receive highly relevant requests by considering the user's geographic location information. Specifically, the reception unit inputs geographic location information such as GPS coordinates obtained from the user terminal (e.g., latitude 35.6812, longitude 139.7671), location accuracy, stay history, and movement speed as feature vectors into an AI model. As the AI model, a neural network suitable for geographic clustering or location information classification (e.g., multilayer perceptron or Transformer-based model handling geographic features) can be used. Examples of AI input include “Current location: Around Tokyo Station, In transit” and “Current location: Home, Stationary.” Examples of AI output include “Recommended reception category: Tokyo tourist spot related, Score 0.95” and “Recommended reception category: Home vicinity information, Score 0.88.” Based on the AI output, the reception unit executes subsequent processing such as prioritizing the display of request items related to the current location or destination on the reception screen, hiding unnecessary items, or dynamically switching the parameters of the reception algorithm. Geographic information-based reception optimization by AI is technically superior in that it autonomously optimizes the request reception experience according to the user's current location and movement status, unlike manual location selection or static UI design. As a technical effect, the reception unit realizes request reception that matches the user's current location or destination, improves reception efficiency and satisfaction, and achieves reduction of irrelevant requests and advancement of location-linked services. Specific application fields include location-linked reception for tourist guide apps, destination reception for travel support services, home vicinity reception for community-based information services, and on-site reception for urban planning simulations.

The collection unit can analyze the user's social media activity and collect relevant data. For example, if the user posts about tourist spots on social media, the collection unit prioritizes the collection of data related to those tourist spots. Additionally, if the user posts about education on social media, the collection unit can prioritize the collection of data related to education. Furthermore, if the user posts about video production on social media, the collection unit can prioritize the collection of data related to video production. In this way, the collection unit can prioritize the collection of relevant data by analyzing the user's social media activity. Specifically, the collection unit inputs post data obtained from the user's linked social media accounts (e.g., text posts, image posts, hashtags, post date and time, number of likes) into a natural language processing AI or image analysis AI. As the AI model, a Transformer-based text classification model or image feature extraction model is used to extract fields of interest and topic categories from the post content. Examples of AI input include “Post text: ‘Last week, I toured temples in Kyoto’”, “Post image: Landscape photo of a tourist spot”, and “Hashtags: #education #geography.” Examples of AI output include “Interest category: Tourist spot, Score 0.91” and “Interest category: Education, Score 0.87.” Based on the AI output, the collection unit executes subsequent processing such as prioritizing the display of data items related to the user's latest field of interest on the collection screen, hiding unnecessary items, or dynamically switching the parameters of data acquisition API calls. Social media activity analysis by AI is technically superior in that it can optimize the data collection experience in real time by analyzing the user's latest interests and concerns as high-dimensional features, unlike manual post confirmation or static category selection. As a technical effect, the collection unit realizes data collection tailored to the user's latest interests, improves collection efficiency and satisfaction, and achieves reduction of irrelevant data and advancement of trend-linked services. Specific application fields include trend data collection for tourist guide apps, support for educational material creation, topic-linked data acquisition for video production tools, and field of interest data collection for event guide services.

The generation unit can refer to the user's past request history to select a method of generating a 3D map. For example, the generation unit selects the optimal generation method based on 3D maps previously generated by the user. Additionally, the generation unit can preferentially select highly relevant generation methods from the user's past request history. Furthermore, the generation unit can analyze the user's past request history to select the most efficient generation method. In this way, the generation unit can select the optimal generation method by referring to the user's past request history. Specifically, the generation unit acquires request history data accumulated in chronological order for each user (e.g., request content text, reception date and time, type of generated map, required generation time, success/failure flag) from a database. The generation unit inputs these history data as feature vectors (e.g., embedding vectors for request content, one-hot vectors for day of week/time zone, category vectors for type of generated map) into an AI model. As the AI model, a recurrent neural network (LSTM) or a Transformer-based history analysis model with self-attention mechanism, which excels at extracting time-series patterns, can be used. Examples of AI input include request content vectors for the past 30 requests (each 256 dimensions), generation time vectors (24 dimensions), and generated map type vectors (5 dimensions: tourist/education/video/game/other). Examples of AI output include “Recommended generation method: High-resolution voxel generation, Confidence 0.87” and “Recommended generation category: Educational map, Score 0.92.” Based on the AI output, the generation unit automates subsequent processing such as selection of 3D map generation AI algorithms, parameter settings, and switching of data acquisition modes (e.g., low-resolution generation at night). History analysis and generation optimization by AI is technically superior in that it can autonomously provide an optimized 3D map generation experience for each user by analyzing multiple history patterns and usage trends in high-dimensional space, unlike human memory or simple history list display. As a technical effect, the generation unit reduces the user's input burden, improves generation efficiency and satisfaction, and achieves reduction of unnecessary computational resources and shortening of generation time. Specific application fields include personalized generation for tourist guide apps, support for educational material creation, history-based map generation for video production tools, and efficiency-oriented generation for business systems.

The placement unit can adjust the method of placing a character based on the user's current project and field of interest. For example, if the user wants to create a 3D map of a tourist spot, the placement unit prioritizes the placement of characters related to tourist spots. Additionally, if the user wants to create a 3D map for educational purposes, the placement unit can prioritize the placement of characters related to education. Furthermore, if the user wants to create a 3D map for video production, the placement unit can prioritize the placement of characters related to video production. In this way, the placement unit can efficiently place highly relevant characters based on the user's current project and field of interest. Specifically, the placement unit acquires user profile data (e.g., current project name, field of interest tags, past usage history, selected category) and inputs these as feature vectors (e.g., one-hot vectors for project type, embedding vectors for field of interest) into an AI model. As the AI model, a multilayer perceptron or Transformer-based text classification model suitable for category classification can be used. Examples of AI input include “Project type: Tourist map creation, Field of interest: History/Culture” and “Project type: Educational material, Field of interest: Geography/Science.” Examples of AI output include “Recommended placement category: Tourist-related character, Score 0.93” and “Recommended placement category: Education-related character, Score 0.88.” Based on the AI output, the placement unit executes subsequent processing such as prioritizing the display of highly relevant character items on the placement screen, hiding unnecessary items, or dynamically switching the parameters of the placement algorithm. Project and field of interest filtering by AI is technically superior in that it autonomously optimizes the character placement experience according to the user's current purpose and interest, unlike manual category selection or static UI design. As a technical effect, the placement unit realizes character placement that matches the user's purpose, improves placement efficiency and satisfaction, and achieves reduction of erroneous or irrelevant character placement. Specific application fields include project-based character placement for tourist guide apps, support for educational material creation, category-based character placement for video production tools, and purpose-based character placement for business systems.

The distribution unit can refer to the user's past request history to select a method of distribution. For example, the distribution unit selects the optimal distribution method based on content previously distributed by the user. Additionally, the distribution unit can preferentially select highly relevant distribution methods from the user's past request history. Furthermore, the distribution unit can analyze the user's past request history to select the most efficient distribution method. In this way, the distribution unit can select the optimal distribution method by referring to the user's past request history. Specifically, the distribution unit acquires request history data accumulated in chronological order for each user (e.g., request content text, distribution date and time, type of distribution method, required distribution time, success/failure flag) from a database. The distribution unit inputs these history data as feature vectors (e.g., embedding vectors for request content, one-hot vectors for day of week/time zone, category vectors for type of distribution method) into an AI model. As the AI model, a recurrent neural network (LSTM) or a Transformer-based history analysis model with self-attention mechanism, which excels at extracting time-series patterns, can be used. Examples of AI input include request content vectors for the past 30 requests (each 256 dimensions), distribution time vectors (24 dimensions), and distribution method type vectors (5 dimensions: streaming/download/batch/live/other). Examples of AI output include “Recommended distribution method: Streaming, Confidence 0.87” and “Recommended distribution method: Batch distribution, Score 0.92.” Based on the AI output, the distribution unit automates subsequent processing such as selection of distribution engine algorithms, parameter settings, and switching of distribution modes (e.g., batch distribution at night, live distribution during the day). History analysis and distribution optimization by AI is technically superior in that it can autonomously provide an optimized distribution experience for each user by analyzing multiple history patterns and usage trends in high-dimensional space, unlike human memory or simple history list display. As a technical effect, the distribution unit reduces the user's input burden, improves distribution efficiency and satisfaction, and achieves reduction of unnecessary communication resources and shortening of distribution time. Specific application fields include personalized distribution for tourist guide apps, support for educational material delivery, history-based distribution for video production tools, and efficiency-oriented distribution for business systems.

The following is a brief explanation of the processing flow of Example of the Embodiment. Specifically, the present system operates in cooperation among the reception unit, collection unit, generation unit, placement unit, and distribution unit, and realizes personalized processing tailored to the user's state and purpose of use through high-dimensional feature analysis and dynamic parameter optimization by AI models. The reception unit receives requests from the user (e.g., text, voice, image, location information, past history, emotion data, etc.) in various input formats, and performs input format estimation and request content classification by AI. The collection unit inputs the request content received from the reception unit, user profile, geographic location information, social media activity, etc. into an AI model, estimates highly relevant data types and collection priorities, and efficiently collects necessary data from databases and external APIs. The generation unit inputs various data obtained from the collection unit (e.g., satellite images, geographic information, sensor data, user state data, etc.) into an AI model, dynamically determines 3D map generation algorithms and effect parameters, and generates 3D maps optimized for the user's state and project purpose. The placement unit inputs the 3D map data output from the generation unit and user emotion/project information, etc. into an AI model, automatically determines character types, placement coordinates, and movement patterns, and executes placement strategies to maximize user experience. The distribution unit inputs the 3D map and character information received from the placement unit, user state, network status, etc. into an AI model, optimizes parameters such as distribution method, speed, and effect application, and realizes real-time, high-quality distribution to user terminals. At each step, the AI model performs technical processing such as high-dimensional feature extraction from input data, time-series pattern analysis, category classification, priority estimation, and parameter optimization, and achieves autonomous and dynamic system optimization that differs from conventional human work or static rule-based processing. As a technical effect, the present system realizes personalized processing tailored to the user's state and purpose of use, reduces unnecessary computational and communication resources, and improves overall processing efficiency and user satisfaction. Specific application fields include user state-adaptive services for tourist guide apps, support for educational material creation, effect optimization for video production tools, patient state-linked information presentation in medical settings, and on-site optimization for urban planning simulations.

Step 1: The reception unit receives a request from the user. The user's request may include, for example, text format, voice format, or specific actions. Step 2: The collection unit collects data based on the request received by the reception unit. The collected data may include, for example, satellite photographs, geographic information, sensor data, user data, and data from external APIs. Step 3: The generation unit analyzes the data collected by the collection unit and generates a 3D map. The generated 3D map may include, for example, voxel-based, polygon-based, or the software used. Step 4: The placement unit places a character on the 3D map generated by the generation unit. The placed character may include, for example, character type, placement location, movement, and placement algorithm. Step 5: The distribution unit distributes the 3D map including the character placed by the placement unit. The distribution method may include, for example, streaming, downloading, or the protocol used. Specifically, in Step 1, the reception unit receives input data from the user terminal (e.g., text command, voice command, image, location information, emotion data, etc.), inputs it into an AI model (e.g., large language model, speech recognition AI, image classification AI, etc.), and estimates the request type and input format. In Step 2, the collection unit inputs the request content received from the reception unit, user profile, geographic location information, social media activity, etc. into an AI model (e.g., Transformer-based classification model, time-series analysis model, etc.), estimates highly relevant data types and collection priorities, and efficiently collects necessary data from databases and external APIs. In Step 3, the generation unit inputs various data obtained from the collection unit (e.g., satellite images, geographic information, sensor data, user state data, etc.) into an AI model (e.g., 3D convolutional neural network, extended Transformer, etc.), dynamically determines 3D map generation algorithms and effect parameters, and generates 3D maps optimized for the user's state and project purpose. In Step 4, the placement unit inputs the 3D map data output from the generation unit and user emotion/project information, etc. into an AI model (e.g., reinforcement learning agent, rule-based placement AI, etc.), automatically determines character types, placement coordinates, and movement patterns, and executes placement strategies to maximize user experience. In Step 5, the distribution unit inputs the 3D map and character information received from the placement unit, user state, network status, etc. into an AI model (e.g., reinforcement learning agent for distribution control, distribution optimization algorithm, etc.), optimizes parameters such as distribution method, speed, and effect application, and realizes real-time, high-quality distribution to user terminals. At each step, the AI model performs technical processing such as high-dimensional feature extraction from input data, time-series pattern analysis, category classification, priority estimation, and parameter optimization, and achieves autonomous and dynamic system optimization that differs from conventional human work or static rule-based processing. As a technical effect, the present system realizes personalized processing tailored to the user's state and purpose of use, reduces unnecessary computational and communication resources, and improves overall processing efficiency and user satisfaction. Specific application fields include user state-adaptive services for tourist guide apps, support for educational material creation, effect optimization for video production tools, patient state-linked information presentation in medical settings, and on-site optimization for urban planning simulations.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned reception unit, collection unit, generation unit, placement unit, and distribution unit is implemented by at least one of, for example, the smart device 14 and the data processing apparatus 12. For example, the reception unit is implemented by a control unit 46A of the smart device 14 and receives a request from a user. The collection unit is implemented, for example, by a specific processing unit 290 of the data processing apparatus 12 and collects data based on the request. The generation unit is implemented, for example, by the specific processing unit 290 of the data processing apparatus 12 and analyzes the collected data to generate a 3D map. The placement unit is implemented, for example, by the control unit 46A of the smart device 14 and places a character on the generated 3D map. The distribution unit is implemented, for example, by the control unit 46A of the smart device 14 and distributes the generated 3D map and character through a dedicated application. The correspondence between each unit and the device or control unit is not limited to the examples described above and various modifications are possible.

### Second Embodiment

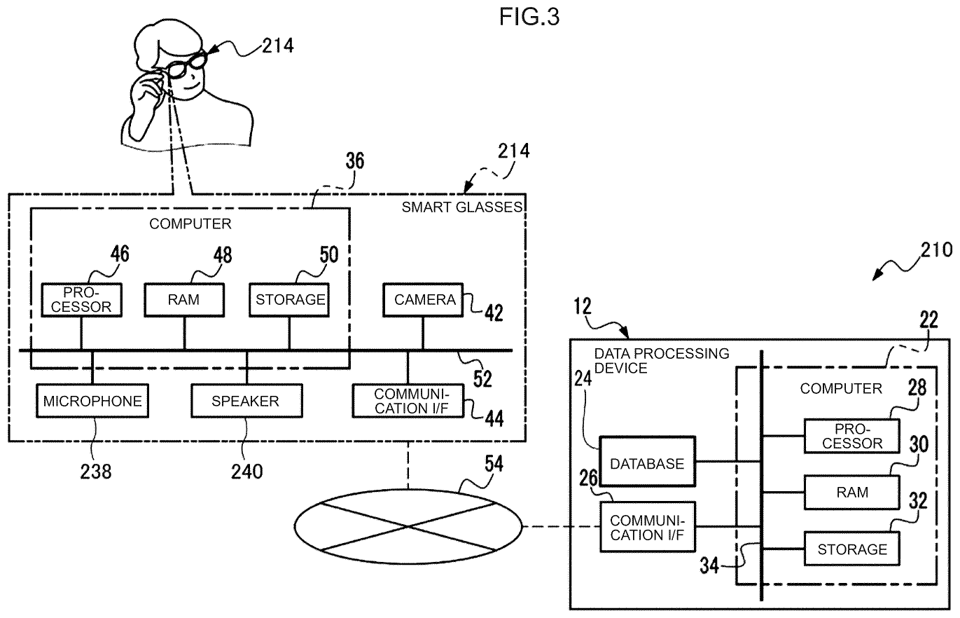

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

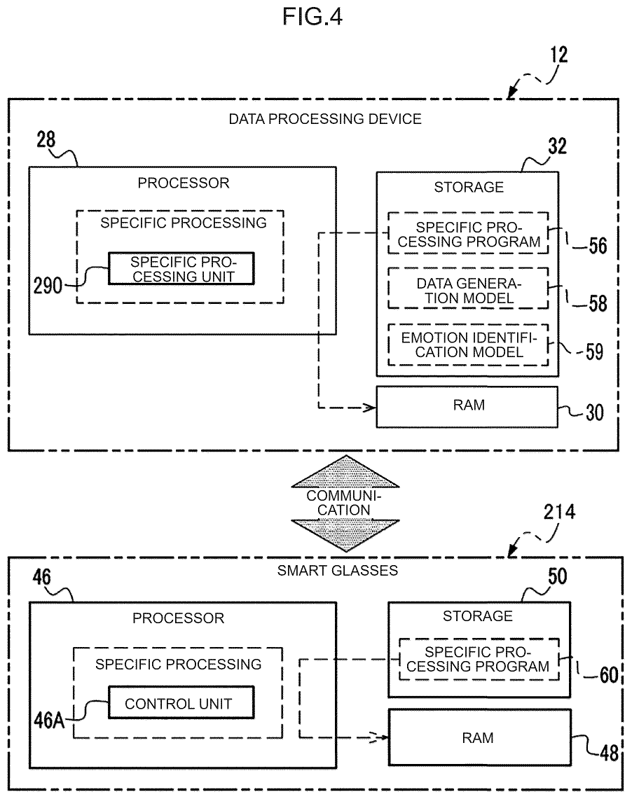

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned reception unit, collection unit, generation unit, placement unit, and distribution unit is implemented by at least one of, for example, the smart glasses 214 and the data processing apparatus 12. For example, the reception unit is implemented by a control unit 46A of the smart glasses 214 and receives a request from a user. The collection unit is implemented, for example, by a specific processing unit 290 of the data processing apparatus 12 and collects data based on the request. The generation unit is implemented, for example, by the specific processing unit 290 of the data processing apparatus 12 and analyzes the collected data to generate a 3D map. The placement unit is implemented, for example, by the control unit 46A of the smart glasses 214 and places a character on the generated 3D map. The distribution unit is implemented, for example, by the control unit 46A of the smart glasses 214 and distributes the generated 3D map and character through a dedicated application. The correspondence between each unit and the device or control unit is not limited to the examples described above and various modifications are possible.

### Third Embodiment

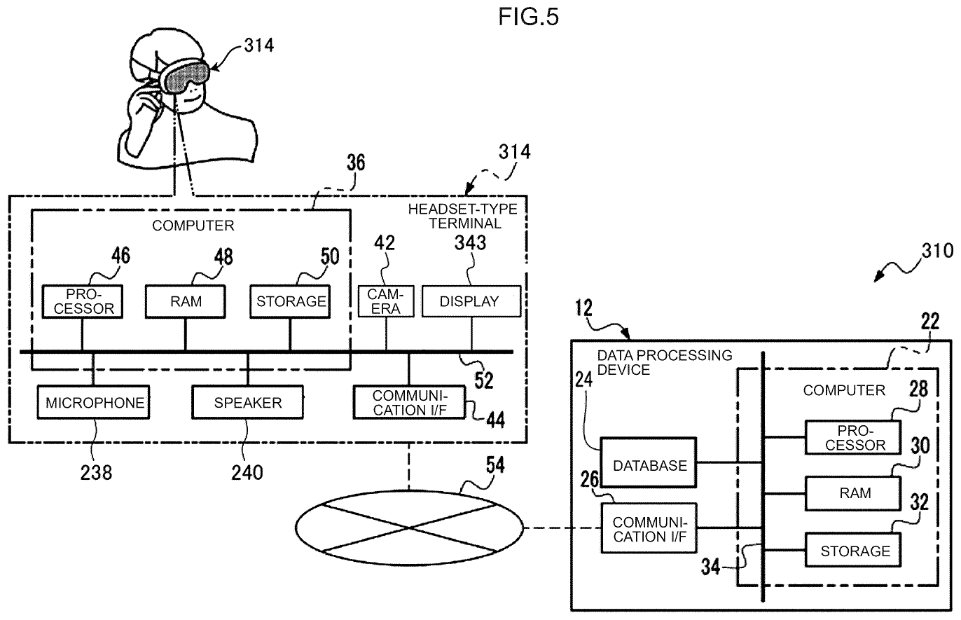

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

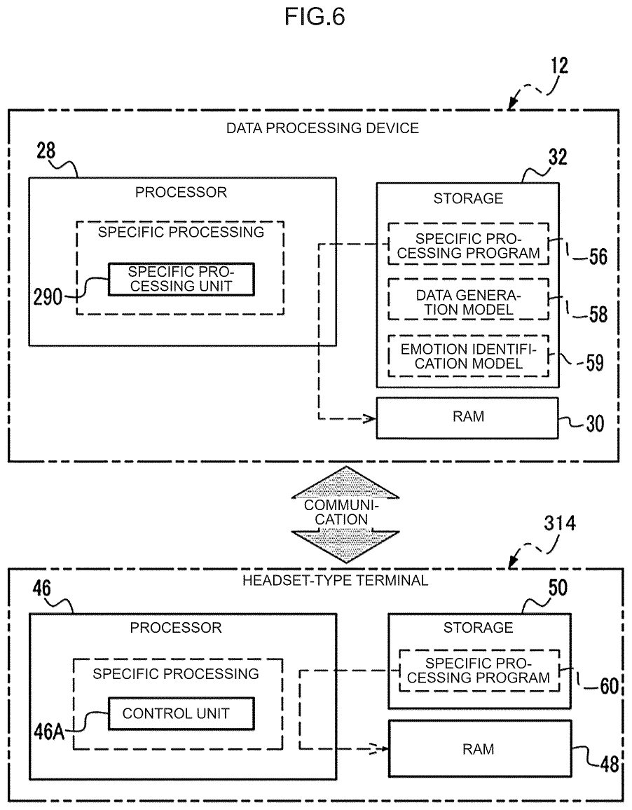

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned reception unit, collection unit, generation unit, placement unit, and distribution unit is implemented by at least one of, for example, the headset-type terminal 314 and the data processing apparatus 12. For example, the reception unit is implemented by a control unit 46A of the headset-type terminal 314 and receives a request from a user. The collection unit is implemented, for example, by a specific processing unit 290 of the data processing apparatus 12 and collects data based on the request. The generation unit is implemented, for example, by the specific processing unit 290 of the data processing apparatus 12 and analyzes the collected data to generate a 3D map. The placement unit is implemented, for example, by the control unit 46A of the headset-type terminal 314 and places a character on the generated 3D map. The distribution unit is implemented, for example, by the control unit 46A of the headset-type terminal 314 and distributes the generated 3D map and character through a dedicated application. The correspondence between each unit and the device or control unit is not limited to the examples described above and various modifications are possible.

### Fourth Embodiment

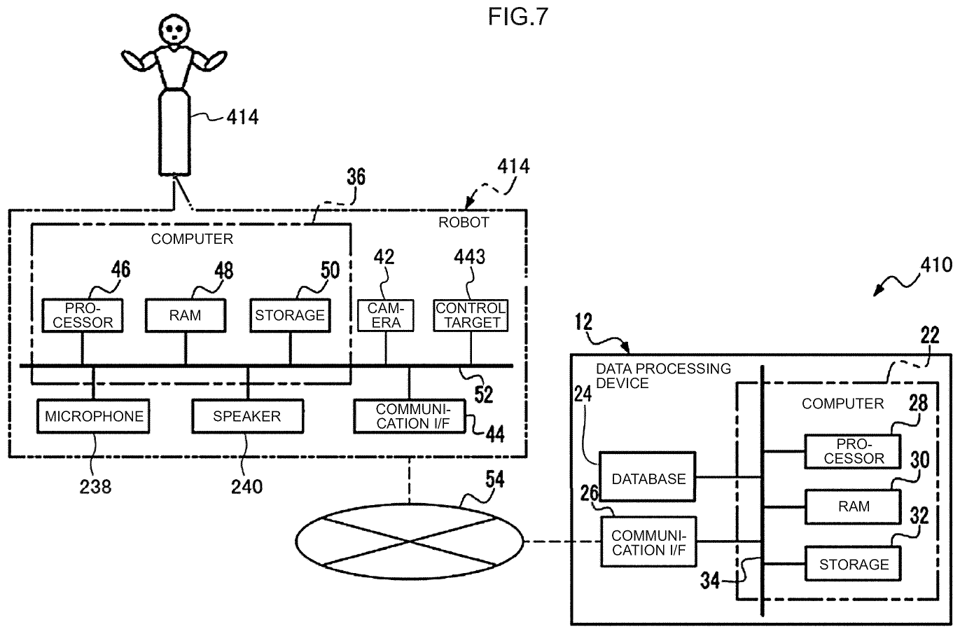

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

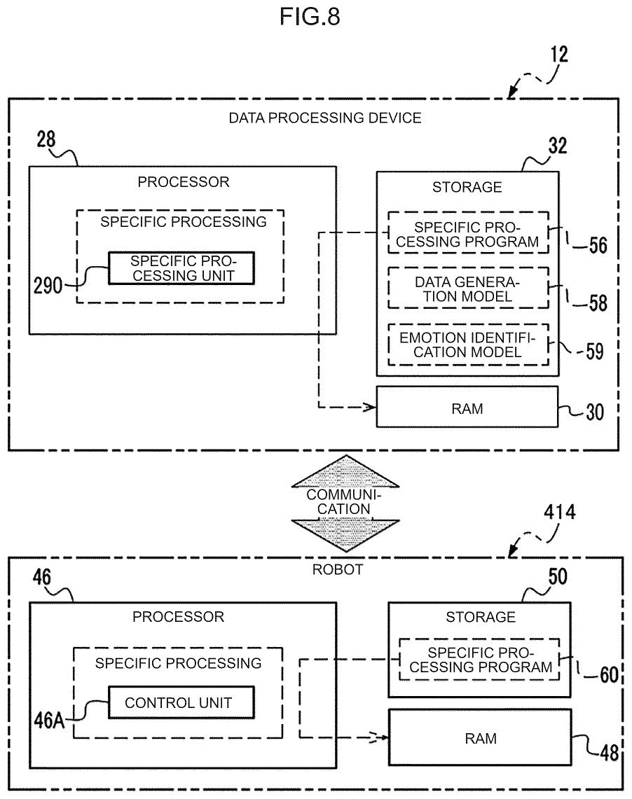

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned reception unit, collection unit, generation unit, placement unit, and distribution unit is implemented by at least one of, for example, the robot 414 and the data processing apparatus 12. For example, the reception unit is implemented by a control unit 46A of the robot 414 and receives a request from a user. The collection unit is implemented, for example, by a specific processing unit 290 of the data processing apparatus 12 and collects data based on the request. The generation unit is implemented, for example, by the specific processing unit 290 of the data processing apparatus 12 and analyzes the collected data to generate a 3D map. The placement unit is implemented, for example, by the control unit 46A of the robot 414 and places a character on the generated 3D map. The distribution unit is implemented, for example, by the control unit 46A of the robot 414 and distributes the generated 3D map and character through a dedicated application. The correspondence between each unit and the device or control unit is not limited to the examples described above and various modifications are possible.

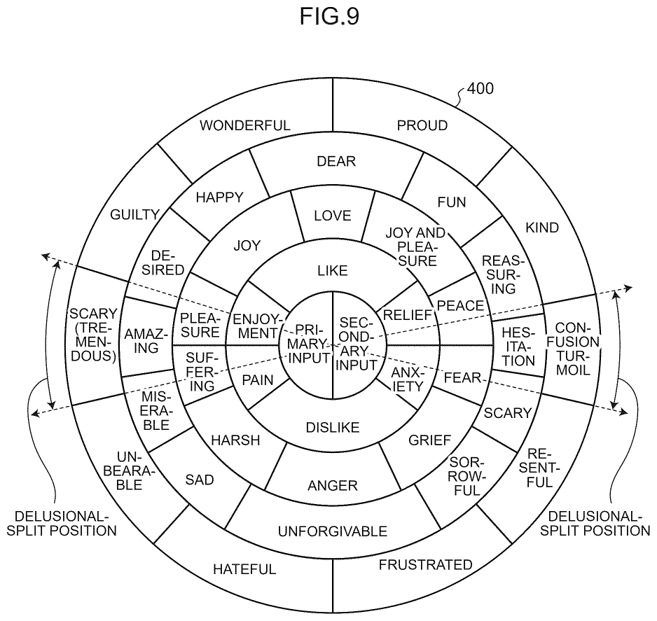

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

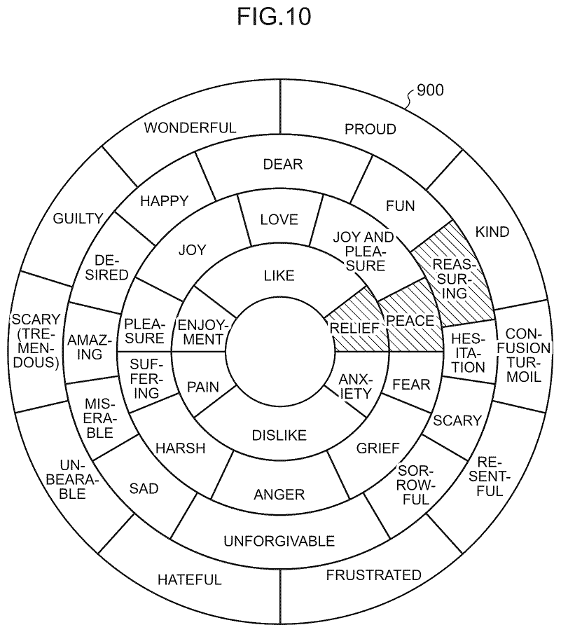

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a reception unit configured to receive a request from a user; a collection unit configured to collect data based on the request received by the reception unit; a generation unit configured to analyze the data collected by the collection unit and generate a 3D map; a placement unit configured to place a character on the 3D map generated by the generation unit; and a distribution unit configured to distribute the 3D map including the character placed by the placement unit.
(Supplementary Note 2) The system according to Supplementary Note 1, wherein the collection unit is configured to collect satellite photographs or geographic information.
(Supplementary Note 3) The system according to Supplementary Note 1, wherein the generation unit is configured to generate a voxel 3D map.
(Supplementary Note 4) The system according to Supplementary Note 1, wherein the placement unit is configured to place a character on the 3D map based on the user's request.
(Supplementary Note 5) The system according to Supplementary Note 1, wherein the distribution unit is configured to distribute the generated 3D map and character through an application.
(Supplementary Note 6) The system according to Supplementary Note 1, wherein the distribution unit is configured to sell content generated by a creator and obtain revenue.
(Supplementary Note 7) The system according to Supplementary Note 1, wherein the reception unit is configured to estimate a user's emotion and adjust a method of receiving a request based on the estimated emotion of the user.
(Supplementary Note 8) The system according to Supplementary Note 1, wherein the reception unit is configured to analyze a user's past request history and select an appropriate reception method.
(Supplementary Note 9) The system according to Supplementary Note 1, wherein the reception unit is configured to perform filtering based on the user's current project or field of interest when receiving a request.
(Supplementary Note 10) The system according to Supplementary Note 1, wherein the reception unit is configured to estimate a user's emotion and determine the priority of requests to be received based on the estimated emotion of the user.
(Supplementary Note 11) The system according to Supplementary Note 1, wherein the reception unit is configured to preferentially receive highly relevant requests by considering the user's geographic location information when receiving a request.
(Supplementary Note 12) The system according to Supplementary Note 1, wherein the reception unit is configured to analyze the user's social media activity and receive relevant requests when receiving a request.
(Supplementary Note 13) The system according to Supplementary Note 1, wherein the collection unit is configured to estimate a user's emotion and adjust a method of data collection based on the estimated emotion of the user.
(Supplementary Note 14) The system according to Supplementary Note 1, wherein the collection unit is configured to refer to the user's past request history and select an appropriate data collection method when collecting data.
(Supplementary Note 15) The system according to Supplementary Note 1, wherein the collection unit is configured to perform filtering based on the user's current project or field of interest when collecting data.
(Supplementary Note 16) The system according to Supplementary Note 1, wherein the collection unit is configured to estimate a user's emotion and determine the priority of data to be collected based on the estimated emotion of the user.
(Supplementary Note 17) The system according to Supplementary Note 1, wherein the collection unit is configured to preferentially collect highly relevant data by considering the user's geographic location information when collecting data.
(Supplementary Note 18) The system according to Supplementary Note 1, wherein the collection unit is configured to analyze the user's social media activity and collect relevant data when collecting data.
(Supplementary Note 19) The system according to Supplementary Note 1, wherein the generation unit is configured to estimate a user's emotion and adjust a method of generating a 3D map based on the estimated emotion of the user.
(Supplementary Note 20) The system according to Supplementary Note 1, wherein the generation unit is configured to refer to the user's past request history and select an appropriate method of generating a 3D map when generating the 3D map.
(Supplementary Note 21) The system according to Supplementary Note 1, wherein the generation unit is configured to perform filtering based on the user's current project or field of interest when generating a 3D map.
(Supplementary Note 22) The system according to Supplementary Note 1, wherein the generation unit is configured to estimate a user's emotion and determine the priority of 3D maps to be generated based on the estimated emotion of the user.
(Supplementary Note 23) The system according to Supplementary Note 1, wherein the generation unit is configured to preferentially generate highly relevant 3D maps by considering the user's geographic location information when generating a 3D map.
(Supplementary Note 24) The system according to Supplementary Note 1, wherein the generation unit is configured to analyze the user's social media activity and generate relevant 3D maps when generating a 3D map.
(Supplementary Note 25) The system according to Supplementary Note 1, wherein the placement unit is configured to estimate a user's emotion and adjust a method of placing a character based on the estimated emotion of the user.
(Supplementary Note 26) The system according to Supplementary Note 1, wherein the placement unit is configured to refer to the user's past request history and select an appropriate placement method when placing a character.
(Supplementary Note 27) The system according to Supplementary Note 1, wherein the placement unit is configured to perform filtering based on the user's current project or field of interest when placing a character.
(Supplementary Note 28) The system according to Supplementary Note 1, wherein the placement unit is configured to estimate a user's emotion and determine the priority of characters to be placed based on the estimated emotion of the user.
(Supplementary Note 29) The system according to Supplementary Note 1, wherein the placement unit is configured to preferentially place highly relevant characters by considering the user's geographic location information when placing a character.
(Supplementary Note 30) The system according to Supplementary Note 1, wherein the placement unit is configured to analyze the user's social media activity and place relevant characters when placing a character.
(Supplementary Note 31) The system according to Supplementary Note 1, wherein the distribution unit is configured to estimate a user's emotion and adjust a method of distribution based on the estimated emotion of the user.
(Supplementary Note 32) The system according to Supplementary Note 1, wherein the distribution unit is configured to refer to the user's past request history and select an appropriate distribution method when distributing.
(Supplementary Note 33) The system according to Supplementary Note 1, wherein the distribution unit is configured to perform filtering based on the user's current project or field of interest when distributing.
(Supplementary Note 34) The system according to Supplementary Note 1, wherein the distribution unit is configured to estimate a user's emotion and determine the priority of content to be distributed based on the estimated emotion of the user.
(Supplementary Note 35) The system according to Supplementary Note 1, wherein the distribution unit is configured to preferentially distribute highly relevant content by considering the user's geographic location information when distributing.
(Supplementary Note 36) The system according to Supplementary Note 1, wherein the distribution unit is configured to analyze the user's social media activity and distribute relevant content when distributing.

What is claimed is:

1. A system comprising:
circuitry configured to:
receive, via a communication interface coupled to a packet-switched network, request data from a client terminal, the request data comprising at least one of text data or voice data;
extract, by inputting the request data into a neural network comprising a Transformer-based encoder, intent parameters from the request data, the intent parameters comprising at least a geographic range indicator and a detail level indicator;
acquire, from an external data source via the communication interface and the packet-switched network, structured data comprising at least one of image tensors or multidimensional feature vectors, based on the intent parameters;
generate, by inputting the structured data into a data generation model obtained by deep learning on a neural network, the data generation model comprising at least one of a three-dimensional convolutional neural network or a Transformer-based generative model, a three-dimensional voxel grid comprising a multidimensional array in which each voxel is labeled with a surface type and an elevation value;
determine, by inputting placement parameters and feature data extracted from the three-dimensional voxel grid into a reinforcement learning model, object coordinates and a behavior sequence for at least one object to be integrated with the three-dimensional voxel grid; and
transmit, to the client terminal via the communication interface and the packet-switched network, output data comprising the three-dimensional voxel grid integrated with the at least one object.

2. The system according to claim 1, wherein the structured data comprises satellite image tensors having RGB values at a resolution of at least 1024 by 1024 pixels and geographic information vectors comprising elevation data and feature label arrays.

3. The system according to claim 1, wherein the three-dimensional voxel grid comprises a three-dimensional array of at least 256 by 256 by 64 voxels, and wherein the data generation model is pre-trained with a teacher dataset comprising pairs of satellite images and corresponding terrain data using a loss function comprising at least one of a terrain reproduction error or a surface type classification error.

4. The system according to claim 1, wherein the placement parameters comprise a object type vector encoded as a one-hot vector, a placement candidate coordinate list comprising a three-dimensional coordinate array, and a terrain feature tensor comprising elevation, surface type, and presence of obstacles, and wherein the reinforcement learning model outputs the object coordinates and the behavior sequence as structured data comprising an object identifier, three-dimensional coordinates, and an action script.

5. The system according to claim 1, wherein the circuitry is further configured to convert the three-dimensional voxel grid and object data into a data format comprising at least one of glTF, FBX, or a proprietary binary format, and to transmit the converted data via at least one of streaming distribution or download distribution.

6. The system according to claim 1, wherein the circuitry is further configured to estimate an emotion of a user by applying an emotion identification model to sensor data received from the client terminal via the communication interface, and to adjust at least one of a detail level or a generation speed of the three-dimensional voxel grid based on the estimated emotion, such that when the estimated emotion indicates relaxation, the circuitry generates a high-resolution voxel grid, and when the estimated emotion indicates urgency, the circuitry generates a low-resolution voxel grid.

7. The system according to claim 6, wherein the emotion identification model comprises a multimodal neural network integrating a convolutional neural network and a recurrent neural network, and wherein the emotion identification model outputs an emotion label as a probability distribution over a plurality of emotion categories and an emotion intensity score.

8. The system according to claim 6, wherein the sensor data comprises at least one of voice data captured by a microphone of the client terminal, image data captured by a camera of the client terminal having a CMOS image sensor, or biometric data comprising heart rate and skin conductance.

9. The system according to claim 1, wherein the circuitry is further configured to estimate an emotion of a user by applying an emotion identification model to sensor data received from the client terminal, and to adjust a method of transmitting the output data based on the estimated emotion, such that when the estimated emotion indicates relaxation, the circuitry sets a low distribution speed and extends buffering, and when the estimated emotion indicates urgency, the circuitry selects a low-latency protocol and transmits only minimum necessary data.

10. The system according to claim 1, wherein the circuitry is further configured to analyze a past request history of a user stored in a database, the past request history comprising request content text, reception timestamps, and interface type identifiers recorded in chronological order, by inputting the past request history as feature vectors into a history analysis model comprising at least one of a recurrent neural network or a Transformer-based model with a self-attention mechanism, and to select a reception method for the request data based on an output of the history analysis model.

11. The system according to claim 1, wherein the circuitry is further configured to perform filtering on the request data based on a current project identifier or a field-of-interest tag associated with a user, by inputting user profile data comprising the current project identifier and the field-of-interest tag as feature vectors into a classification model comprising at least one of a multilayer perceptron or a Transformer-based text classification model, and to prioritize processing of the request data based on a relevance score output by the classification model.

12. The system according to claim 1, wherein the circuitry is further configured to receive geographic location information comprising latitude and longitude coordinates from the client terminal, and to adjust a priority of the structured data to be acquired based on the geographic location information, such that the circuitry preferentially acquires structured data associated with a geographic region corresponding to the geographic location information.

13. The system according to claim 1, wherein the circuitry is further configured to analyze social media activity data of a user, the social media activity data comprising at least one of text posts, image posts, or hashtags, by inputting the social media activity data into at least one of a Transformer-based text classification model or an image feature extraction model, and to adjust at least one of the intent parameters or the placement parameters based on an interest category score output by the model.

14. The system according to claim 1, wherein the circuitry is further configured to dynamically adjust at least one of a voxel size of the three-dimensional voxel grid, a number of convolutional layers of the three-dimensional convolutional neural network, or a number of attention heads of the Transformer-based generative model, based on at least one of a user request or a system load.

15. The system according to claim 1, wherein the circuitry is further configured to estimate an emotion of a user and to adjust at least one of a type, a placement location, or a behavior pattern of the at least one object based on the estimated emotion, such that when the estimated emotion indicates excitement, the circuitry places objects having visually dynamic behavior patterns, and when the estimated emotion indicates relaxation, the circuitry places objects having calm behavior patterns.

16. The system according to claim 1, wherein the circuitry is further configured to analyze a past request history of a user to determine a preferred object type and a preferred placement style, and to adjust the placement parameters based on the preferred object type and the preferred placement style.

17. The system according to claim 1, wherein the output data further comprises at least one of a polygon mesh or texture mapping information, and wherein the circuitry is further configured to add dynamic visual effects to the output data comprising at least one of colorful transitions, dynamic animations, or special light sources when an estimated emotion of a user indicates excitement.

18. A system comprising:
circuitry configured to:
receive, via a communication interface coupled to a packet-switched network, request data from a client terminal, the request data comprising at least one of text data tokenized and normalized by a preprocessing module, or voice data converted into a voice spectrum;
extract, by inputting the request data into a Transformer-based encoder that performs semantic analysis on an input sentence, intent parameters comprising a geographic range, a purpose category, and a required detail level from the request data;
acquire, from an external data source via the communication interface and the packet-switched network, satellite image tensors comprising a two-dimensional array of at least 1024 by 1024 pixels with RGB values, and geographic information vectors comprising elevation value arrays and feature label arrays;
preprocess the satellite image tensors by performing noise removal, resizing, and normalization, and preprocess the geographic information vectors by performing coordinate system conversion and vectorization, to generate a high-dimensional input tensor;
generate, by inputting the high-dimensional input tensor into a data generation model comprising a three-dimensional convolutional neural network pre-trained with a teacher dataset of satellite images and geographic information using a loss function comprising a terrain reproduction error based on mean squared error of elevation values and a surface type classification error based on cross-entropy loss, a three-dimensional voxel grid comprising a multidimensional array of at least 256 by 256 by 64 voxels in which each voxel is labeled with a surface type and an elevation value;
determine, by inputting an object type vector encoded as a one-hot vector, a placement candidate coordinate list comprising a three-dimensional coordinate array, and a terrain feature tensor into a reinforcement learning model, object coordinates and a behavior sequence for at least one object, the reinforcement learning model simultaneously considering terrain information and placement status of existing objects to maximize a reward function comprising collision avoidance and user experience improvement; and
transmit, to the client terminal via the communication interface and the packet-switched network, output data comprising the three-dimensional voxel grid integrated with the at least one object in a data format comprising at least one of glTF or FBX.

19. The system according to claim 18, wherein the circuitry is further configured to estimate an emotion of a user by applying an emotion identification model comprising a multimodal Transformer that receives at least a facial feature vector extracted from image data captured by a CMOS image sensor of the client terminal, a voice spectrum vector extracted from voice data captured by a microphone of the client terminal, and a biometric sensor statistical vector, and to dynamically adjust at least one of the required detail level or a generation speed of the three-dimensional voxel grid based on the estimated emotion.

20. A method performed by circuitry of a system, the method comprising:
receiving, via a communication interface coupled to a packet-switched network, request data from a client terminal, the request data comprising at least one of text data or voice data;
extracting, by inputting the request data into a neural network comprising a Transformer-based encoder, intent parameters from the request data, the intent parameters comprising at least a geographic range indicator and a detail level indicator;
acquiring, from an external data source via the communication interface and the packet-switched network, structured data comprising at least one of image tensors or multidimensional feature vectors, based on the intent parameters;
generating, by inputting the structured data into a data generation model obtained by deep learning on a neural network, the data generation model comprising at least one of a three-dimensional convolutional neural network or a Transformer-based generative model, a three-dimensional voxel grid comprising a multidimensional array in which each voxel is labeled with a surface type and an elevation value;
determining, by inputting placement parameters and feature data extracted from the three-dimensional voxel grid into a reinforcement learning model, object coordinates and a behavior sequence for at least one object to be integrated with the three-dimensional voxel grid; and
transmitting, to the client terminal via the communication interface and the packet-switched network, output data comprising the three-dimensional voxel grid integrated with the at least one object.
